(19) United States
(12) Patent Application Publication
(10) Pub. No.: US 2026/0291819 A1
(43) Pub. Date: Sep. 24, 2026

(54) SYSTEM

(71) Applicant: SoftBank Group Corp., Tokyo (JP)

(72) Inventor: Hiroyuki MIZUNO, Tokyo (JP)

(73) Assignee: SoftBank Group Corp., Tokyo (JP)

(21) Appl. No.: 19/564,598

(22) Filed: Mar. 12, 2026

(30) Foreign Application Priority Data
Mar. 19, 2025 (JP) 2025-044948

(51) Int. Cl. H04L 41/14; H04L 41/16; H04L 41/22

(52) U.S. Cl. CPC H04L 41/145; H04L 41/16; H04L 41/22

(57) ABSTRACT

A system includes a processor that is configured to store a network deployment status in a database, create, on the basis of the stored data, a prompt sentence for instructing requirements necessary for generation of a network configuration diagram by using a generative AI model, and input the prompt sentence to the generative AI model and generate an optimal network configuration diagram.

### CROSS-REFERENCE TO RELATED APPLICATION

This application is based on and claims priority under 35 USC 119 from Japanese Patent Application No. 2025-044948 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional techniques for designing network configuration diagrams require specialized network knowledge and manual design work by skilled engineers. As a result, on-site staff or users without sufficient expertise cannot easily create an appropriate network configuration diagram even when information regarding devices, network addresses, or routing requirements is available. In addition, although generative AI models are becoming available, conventional systems do not effectively utilize such models based on the actual network deployment status stored in a database, and therefore cannot automatically generate optimal network configuration diagrams tailored to specific introduction conditions. Furthermore, conventional systems do not adequately provide complementary information, such as network address design or route control, nor do they flexibly adjust prompts for generative AI models according to changes in the network deployment status. Accordingly, there is a need for a system that can store network deployment status, generate prompts suitable for use with a generative AI model, and automatically obtain an optimal network configuration diagram and related network design information, even for users lacking network expertise.

### SUMMARY

In order to solve the above-described problems, a system according to one aspect of the present invention comprises a processor, wherein the processor is configured to store a network deployment status in a database, create, on the basis of the stored data, a prompt sentence for instructing requirements necessary for generation of a network configuration diagram by using a generative AI model, and input the prompt sentence to the generative AI model and generate an optimal network configuration diagram. In this system, the processor may be configured to provide information relating to network address design and route control, thereby assisting a user in understanding and implementing IP addressing schemes and routing policies corresponding to the generated network configuration diagram. Furthermore, the processor may be configured to adjust the prompt on the basis of the network deployment status, so that the content and level of detail of the prompt are dynamically adapted to additions, deletions, or changes in network devices or design requirements, and the generative AI model can continuously produce network configuration diagrams that reflect the latest deployment conditions.

The term “processor” refers to a hardware or virtual computing unit, such as a CPU, GPU, microcontroller, or a combination thereof, that executes instructions to perform the functions defined in the claims, including data storage, prompt generation, and interaction with a generative AI model.

The term “network deployment status” refers to information indicating a current or planned state of a network, including at least one of types and numbers of network devices, their roles, connection relationships, locations, configuration parameters, and operational conditions.

The term “database” refers to a structured data storage system, implemented by software and hardware, that stores and manages the network deployment status and other related data in a persistently retrievable manner.

The term “generative AI model” refers to a machine learning model, such as a large language model, that generates outputs including text, diagrams, or structured data in response to input prompts.

The term “network configuration diagram” refers to a representation, in graphical or structured form, of a network topology, including nodes such as routers, switches, firewalls, and links or connections among the nodes.

The term “prompt sentence” refers to a text or text-like data structure that specifies requirements, conditions, and constraints for the generative AI model to generate a network configuration diagram or related outputs.

The term “optimal network configuration diagram” refers to a network configuration diagram that satisfies predefined criteria, such as reliability, performance, scalability, or compliance with user-specified requirements, based on the network deployment status.

The term “network address design” refers to a design or planning of address allocation in a network, including assignment and structuring of IP addresses, subnets, and related addressing schemes.

The term “route control” refers to policies and configurations for determining paths of packet forwarding in a network, including at least one of routing protocols, static routes, and traffic control rules.

The term “prompt” refers to any input data, including the prompt sentence or an adjusted version thereof, that is provided to the generative AI model to instruct the generation of the network configuration diagram or related information.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

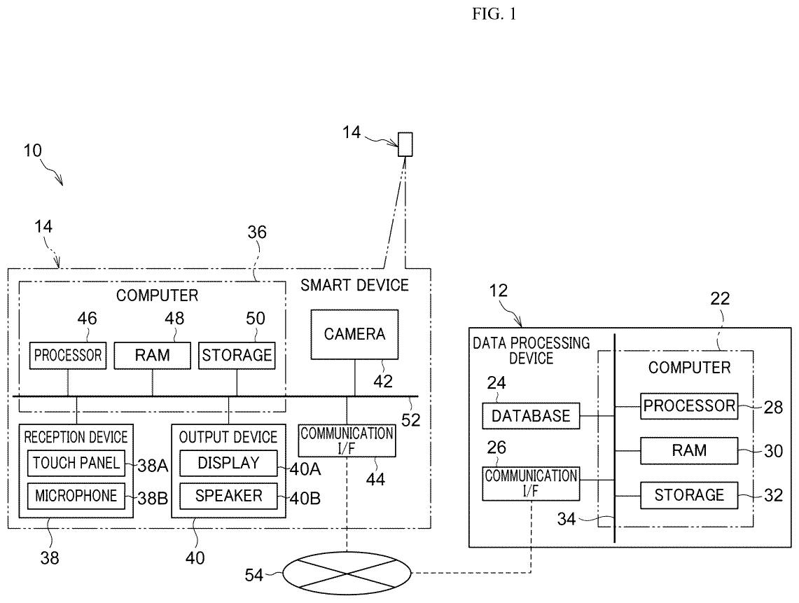

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

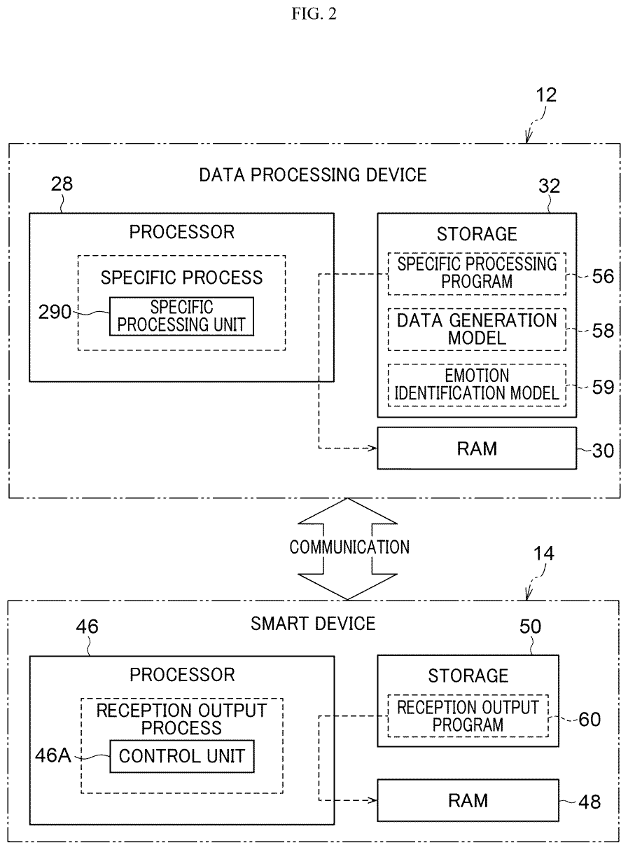

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional techniques for designing network configurations require human experts to interpret deployment requirements, encode those requirements into low-level configuration data, and manually create network configuration diagrams. In systems where non-expert users input high-level deployment information, servers typically store such information and present it directly to human operators or static rule engines. As a result, the following technical problems arise.

First, the server is not configured to automatically transform structured deployment information into an effective input for a generative AI model. In particular, existing systems do not generate, from stored deployment data, a machine-generated prompt sentence that optimally constrains and guides a generative AI model to produce a consistent network topology. This leads to inefficient use of computational resources, including repeated trial-and-error interactions with the model, increased network traffic for multiple API calls, and higher processing latency.

Second, even when a generative AI model is used, the server usually treats the model output as unstructured text and does not automatically convert it into an internal representation suitable for further machine processing. In such systems, there is no server-side mechanism to parse model output, detect inconsistencies in the suggested topology, or automatically request a revised output from the model. Consequently, the server cannot reliably generate machine-usable configuration diagram data, and the overall processing pipeline remains fragile and dependent on manual interpretation.

Third, because the server does not automatically validate the generative AI output against the original deployment requirements, errors in logical connectivity, missing devices, or inadequate segmentation often remain undetected at the computer-system level. This causes failures in downstream processing, such as automatic diagram layout, and forces human operators to correct inconsistencies by hand. The lack of feedback control between the internal representation and the prompt sentence degrades the technical performance of the server as an information processing apparatus, including degraded reliability, repeatability, and response time.

Fourth, existing systems generally do not extract and encode additional constraints, such as site scale, user count, reliability requirements, and security requirements, into the prompt sentence in a structured and systematic manner. Without such encoding, the generative AI model receives under-specified instructions, which increases the likelihood of suboptimal or incorrect topologies and necessitates additional processing cycles at the server.

Accordingly, there is a need for an improved computer-implemented technique in which the server: (i) programmatically converts stored structured deployment information into a constraint-rich prompt sentence for a generative AI model; (ii) automatically parses and validates the model output into a graph-based internal representation; (iii) detects topological inconsistencies at the server side; (iv) dynamically adjusts the prompt sentence and re-invokes the generative AI model to correct such inconsistencies; and (v) generates configuration diagram data that can be directly output as image data or drawing description data. Such a technique would improve the functioning of the server itself by providing a closed-loop, machine-executable pipeline from user input through AI interaction to validated, renderable network configuration diagrams.

The specific processing by the specific processing unit 290 of the data processing device 12 in Example 1 is realized by the following means.

The present invention provides a server comprising a processor configured to receive, via a communication path, deployment information relating to communication equipment from a user terminal, and store the deployment information as structured data in an information management area of a storage device; acquire the structured data stored in the information management area and generate, based on the structured data, a prompt sentence in a natural language to be used as an input instruction to a generative artificial intelligence model; input, via an external interface, the prompt sentence to the generative artificial intelligence model and acquire explanation information regarding a network connection structure output from the generative artificial intelligence model; analyze the explanation information to generate an internal representation indicating a logical configuration including communication equipment and communication paths, create configuration diagram data that visually represents the communication equipment and the communication paths based on the internal representation, and output the configuration diagram data as image data or drawing description data; extract, from the structured data, information corresponding to a scale of a usage site, a number of users, reliability requirements, and security requirements and add the extracted information as consideration conditions to the prompt sentence; and extract, from the explanation information, descriptions relating to types of communication devices, interconnection relationships, and logical segmentation, and, based on an extraction result, when a configuration inconsistency is detected, modify contents of the prompt sentence and perform re-input of the prompt sentence to the generative artificial intelligence model so as to adjust the configuration diagram data. This enables the server to implement a closed-loop, computer-controlled workflow in which structured deployment information is automatically converted into a constraint-rich prompt sentence, the generative artificial intelligence model output is automatically transformed into a validated internal graph representation, inconsistencies are detected and corrected through iterative prompt refinement, and machine-usable configuration diagram data is generated and output, thereby improving the technical performance, reliability, and efficiency of network configuration diagram generation within the server.

The term “processor” refers to a hardware-based or virtual information processing unit, such as a central processing unit or a processing core, that executes program instructions to perform the functions described in the claims.

The term “system” refers to a combination of hardware components, software components, and communication paths configured to cooperate in executing the processing operations described in the claims.

The term “user terminal” refers to an information processing apparatus operated by a user, such as a general-purpose computer, a portable information device, or a communication-enabled display device, that transmits deployment information and receives presentation information via a communication path.

The term “communication path” refers to a logical or physical transmission medium, such as a wired network, a wireless network, or a combination thereof, through which data is exchanged between the server, the user terminal, and external services.

The term “deployment information” refers to information indicating a planned or existing installation state of communication equipment, including at least device types, device counts, logical locations, and operational requirements of a communication system.

The term “communication equipment” refers to a hardware unit used for data transmission or routing, such as a packet forwarding device, a routing device, a switching device, a security device, or a radio communication device.

The term “storage device” refers to a hardware component or virtualized resource capable of non-transitory storage of data, such as a magnetic storage device, a semiconductor storage device, or a networked storage system.

The term “information management area” refers to a logical storage region within the storage device configured to store and manage structured data used by the processor, including deployment information and related metadata.

The term “structured data” refers to data formatted according to a predefined schema, such as tabular data, hierarchical data, or key-value data, enabling programmatic access, validation, and transformation by the processor.

The term “prompt sentence” refers to a natural language or semi-structured instruction string generated by the processor based on the structured data, and supplied as an input condition to the generative artificial intelligence model.

The term “generative artificial intelligence model” refers to a machine learning model, such as a neural network model trained on example data, that generates output data including natural language text or structured content in response to an input prompt sentence.

The term “external interface” refers to a hardware or software interface, such as an application programming interface or a network communication endpoint, through which the processor transmits the prompt sentence to, and receives output from, the generative artificial intelligence model.

The term “explanation information” refers to output data generated by the generative artificial intelligence model in response to the prompt sentence, the output data including at least a description of a network connection structure and associated logical relationships.

The term “internal representation” refers to a machine-readable data structure generated by the processor based on the explanation information, the data structure expressing a logical configuration of communication equipment and communication paths, for example as a graph or equivalent model.

The term “logical configuration” refers to an abstract representation of roles, connections, and segmentation of communication equipment and communication paths, independent of physical cabling or device mounting locations.

The term “communication path” (in the context of the logical configuration) refers to a logical link or connection relationship between communication equipment, such as a data flow path, a routing path, or a switching path represented in the internal representation.

The term “configuration diagram data” refers to machine-readable layout data that visually represents communication equipment and communication paths, and that can be rendered as image data or drawing description data displaying a network configuration.

The term “image data” refers to digital data representing a visual image, such as a raster image file or a vector graphic file, suitable for display on a screen or printing as a network configuration diagram.

The term “drawing description data” refers to programmatically interpretable drawing information, such as a markup description, a graph description language, or other structured format, that defines graphical elements and their relationships for rendering a network configuration diagram.

The term “presentation information” refers to output information including at least the configuration diagram data and the explanation information, which is provided by the processor to the user terminal for display, storage, or further processing.

The term “usage site” refers to a logical or physical location at which the communication equipment is planned to be installed or is already installed, including, for example, an office, a building, or a facility.

The term “number of users” refers to information indicating an estimated or actual count of end users, devices, or terminals expected to utilize the communication system at the usage site.

The term “reliability requirements” refers to conditions or constraints relating to availability, redundancy, fault tolerance, or continuity of communication services to be realized by the network configuration.

The term “security requirements” refers to conditions or constraints relating to protection against unauthorized access, data leakage, or other security risks, including segmentation, access control, and traffic inspection policies.

The term “types of communication devices” refers to categories or classifications of communication equipment, such as routing devices, switching devices, security devices, or wireless access devices, as described in the explanation information.

The term “interconnection relationships” refers to logical or topological relationships indicating how communication equipment is connected or associated, including upstream and downstream connections, intermediate devices, and branching structures.

The term “logical segmentation” refers to partitioning of a communication system into logical groups or domains, such as address segments, virtual local area networks, or security zones, as described in the explanation information or internal representation.

The term “configuration inconsistency” refers to a state in which the internal representation or explanation information violates one or more constraints derived from the structured data, such as missing required connections, incompatible device relationships, or absence of required segments.

The term “re-input of the prompt sentence” refers to a process in which the processor modifies contents of the prompt sentence based on detection of the configuration inconsistency and transmits the modified prompt sentence again to the generative artificial intelligence model to obtain revised explanation information.

In one embodiment, a server cooperates with a terminal operated by a user to automatically generate and refine network configuration diagrams using a generative AI model and structured deployment information. The server executes a program stored in a non-transitory storage device. The program is implemented, for example, using an application framework such as a web application framework and is executed on a general-purpose computing platform including a central processing unit, a main memory, and a network interface. The server uses a database management system, such as a relational database management system, for storing structured deployment information and uses a diagram generation library for creating visual configuration diagram data.

The terminal operates as a user interface device. The terminal includes a display unit, an input unit, a communication unit, a processor, and a memory. The terminal runs a browser application or a native application. The terminal presents input screens and displays configuration diagrams and explanation information received from the server. The user operates the terminal to input deployment information relating to communication equipment, such as information indicating that routers, switches, and firewalls are to be deployed in a certain office.

The server receives, via a communication path, deployment information relating to communication equipment from the terminal. The server converts the deployment information into structured data according to a predetermined schema. The server, for example, maps free-form text or selection inputs into fields such as site identifier, device category, device quantity, required redundancy level, expected number of users, and security classification. The server stores the structured data into an information management area of a storage device through database access operations. The server may use a table that includes columns for site metadata, device attributes, and constraint attributes. The server ensures data integrity by enforcing schema constraints and by normalizing device categories to canonical forms.

The server generates a prompt sentence based on the structured data. The server implements a prompt generation module as a software component executed by the processor. The prompt generation module uses internal templates and rule sets. The server applies deterministic algorithms to transform the structured data into natural language text. The server, for instance, performs pluralization of device categories based on numeric fields, orders device categories according to network hierarchy (for example, wide-area connection devices, perimeter security devices, core switching devices, access switching devices), and appends constraint phrases reflecting reliability requirements and security requirements.

The server generates, as a concrete example of a prompt sentence, a sentence such as:

“Please generate an optimal network configuration diagram for a new office that will introduce one router and one switch.”

The server generates, as another example, a prompt sentence such as:

“Please generate an optimal network configuration diagram for a headquarters office with about 200 users, including redundant routers, a firewall, core switches, and access switches, and consider segmentation by department, basic security best practices, and high availability for Internet connectivity.”

The server may further generate, as another example, a prompt sentence such as:

“Based on the following device list: two routers, one firewall, two layer-3 switches, and four access switches, please output a recommended network configuration diagram for a medium-sized office with approximately 150 users, including separate segments for servers, employees, and guests.”

The server inputs the generated prompt sentence, via an external interface, to a generative AI model. The generative AI model is implemented, in one embodiment, as a large-scale neural network model deployed on a separate computation platform. The generative AI model uses an encoder-decoder architecture or a transformer-based architecture with multiple layers of self-attention and feed-forward units. The generative AI model processes tokenized representations of the prompt sentence. The generative AI model computes attention scores between tokens, propagates activations through layers of learned weights, and produces output tokens representing explanation information. The generative AI model has been trained using a combination of supervised learning and unsupervised learning on large corpora that include network technology descriptions, configuration examples, and topology patterns.

The server communicates with the generative AI model using an application programming interface. The server converts the prompt sentence into a request that includes model parameters such as temperature, maximum output length, and decoding strategy. The server transmits the request to the generative AI model over a secure network connection. The server receives explanation information generated by the generative AI model, such as a textual description indicating roles of devices, their interconnection relationships, segmentation structures, and high-level parameter suggestions. The server may cause the generative AI model to use beam search or top-k sampling to balance diversity and determinism in the output, thereby improving the quality and reproducibility of explanation information.

The server analyzes the explanation information to generate an internal representation. The server implements an analysis module that uses parsing algorithms and pattern matching techniques. The server defines a grammar or a set of extraction rules to recognize device entities, link entities, and segmentation entities in the explanation information. The server, for example, identifies phrases such as “connect the firewall between the Internet and the core router,” “use VLAN 10 for employees,” or “place access switches downstream of the core switch.” The server maps such phrases into a graph structure including nodes that represent communication devices and edges that represent communication paths. The server attaches attributes to nodes and edges, such as device category, security zone, and link type.

The server generates configuration diagram data based on the internal representation. The server invokes a diagram generation component that converts the graph structure into a layout description. The server calculates node positions using a layout algorithm, such as a hierarchical or force-directed layout, to minimize edge crossings and to align devices according to their logical roles. The server produces drawing description data, such as a graph description language representation, and converts it into image data such as vector graphics or raster graphics. The server stores the configuration diagram data or image data in the storage device or in an external storage system and associates it with identifiers for subsequent retrieval.

The server outputs the configuration diagram data and the explanation information to the terminal as presentation information. The server composes a response that includes at least one of image data and drawing description data, along with textual explanation information. The terminal receives the response and renders the configuration diagram on its display. The terminal shows, on the same screen or on a related screen, the explanation information that describes how the communication devices are arranged and how communication paths are defined. The user inspects the diagram and explanation. The user may revise deployment requirements on the terminal, which causes the server to repeat the generation pipeline with updated structured data and prompt sentences.

In another embodiment, the server further extracts additional constraints from the structured data before generating the prompt sentence. The server identifies a scale of a usage site, a number of users, reliability requirements, and security requirements. The server appends, to the prompt sentence, clauses that encode such constraints in natural language. The server, for example, appends phrases such as “with at least two independent Internet connections,” “with high availability requirements for external connections,” or “with strict segmentation between guest devices and internal servers.” The server thus constrains the generative AI model to generate explanation information that more closely matches technical requirements. This targeted use of structured constraints improves the precision of topology suggestions and reduces the number of re-queries required to obtain a valid configuration, thus reducing communication load and processing time.

In another embodiment, the server detects configuration inconsistencies by analyzing the internal representation. The server defines validation rules that check, for example, connectivity between required endpoints, presence of at least one security device at the network boundary, existence of paths between access segments and service segments, and compliance with redundancy requirements. The server compares the generated graph structure against these rules. When the server detects a configuration inconsistency, such as missing connectivity to a required segment or absence of the required number of redundant devices, the server modifies the contents of the prompt sentence.

The server, in such a case, supplements the prompt sentence with additional corrective clauses, such as “ensure that at least two routers are configured in a redundant pair” or “ensure that every Internet connection passes through a firewall device.” The server then performs re-input of the modified prompt sentence to the generative AI model. The server receives updated explanation information and regenerates the internal representation and configuration diagram data. Through this feedback control loop, the server automatically improves the consistency and correctness of the network configuration diagram without requiring human experts to read and interpret intermediate AI outputs.

The generative AI model, in one embodiment, is trained using a learning method that optimizes a loss function over sequences of tokens. The model uses a cross-entropy loss function to measure the difference between predicted token distributions and ground-truth tokens in training corpora. The model adjusts its weight parameters using a gradient-based optimization algorithm, such as stochastic gradient descent or an adaptive moment estimation method. The training process iteratively updates weights in the attention layers and feed-forward layers to minimize the loss function. The model uses positional encodings to preserve token order information. The model, once trained, is capable of capturing complex patterns in network design descriptions and of producing coherent explanation information in response to the structured, constraint-rich prompt sentences.

The server benefits from this architecture because the server does not merely execute a generic “ask and answer” interaction with the model. The server uses structured data, rule-based prompt construction, validation logic, and iterative refinement to control the behavior of the generative AI model. The server thereby improves computer-centric performance measures, such as reducing the number of external model calls required to obtain a valid configuration, shortening end-to-end processing time, and increasing the proportion of automatically validated configuration diagrams that satisfy technical constraints. The server also improves data management because the internal representation, stored in structured form, can be indexed and reused for subsequent computations, such as automated configuration file generation or network simulation, without re-running the full AI generation process.

The system exhibits technical effects that go beyond mere automation of human thought processes. The server uses algorithmic operations that are specifically tailored to computer execution: data parsing, graph construction, machine-readable diagram generation, consistency checking, and feedback-based prompt modification. These operations, when combined with the generative AI model, enable the server to operate in a non-human, non-conventional manner. A human designer typically does not represent topologies as graph data structures nor perform rule-based validation across large sets of configurations in milliseconds, whereas the server does so using dedicated data structures and processing pipelines. This difference leads to improved scalability, reduced error rates, and higher reproducibility of network configuration diagrams.

The system further reduces communication load by encoding more information into each prompt sentence. The server integrates multiple constraints into a single prompt sentence to guide the generative AI model to produce a sufficiently detailed configuration in one or a small number of model invocations. By comparing this approach with simple repeated queries that gradually refine instructions, the server reduces the total number of network round trips and the total volume of exchanged data between the server and the generative AI platform. The system also improves calculation efficiency because the server reuses intermediate structured representations, such as the internal graph representation, in subsequent refinement iterations, instead of recomputing all processing stages from scratch.

In another embodiment, the server can deploy alternative generative AI models with different architectures. The server may use a sequence-to-sequence model, a recurrent neural network with attention, or an encoder-only or decoder-only transformer. The server may select the model dynamically based on available computation resources or target configuration complexity. The server may also augment training data with synthetic network diagrams and accompanying textual explanations to strengthen the model's capability to produce appropriate explanation information for rare or complex configurations. The server may implement data augmentation techniques, such as random rephrasing of requirements or synthetic combination of topology fragments, to expand the training set and to reduce generalization error.

The server may be configured to support multiple deployment environments. The server may operate in a cloud environment where the generative AI model is provided by an external service. Alternatively, the server may operate in an on-premises environment where the generative AI model runs on a dedicated computation node with one or more parallel processing units. The server may distribute processing tasks such as prompt generation, explanation analysis, and diagram rendering across multiple threads or processes to take advantage of multicore architectures.

The terminal, in another embodiment, can be a handheld device, a desktop device, or an integrated industrial panel. The terminal can display interactive diagrams generated from the configuration diagram data. The terminal can allow the user to select devices or links in the diagram to display the corresponding explanation information, such as which security zone the device belongs to, which virtual network it connects to, or what redundancy strategy it implements. The user can modify design requirements or constraints in a structured way, for example by adjusting a slider for the number of users or by toggling a high-availability option. The server then uses these modifications as new deployment information, regenerating structured data and prompt sentences accordingly.

In a variation, the server may also generate machine-readable configuration artifacts, such as intermediate representations that can be transformed into network device configuration files. The internal representation, being a structured graph, facilitates automatic derivation of interface assignments, routing relationships, and access control lists. While such downstream configuration generation is not required in all embodiments, it illustrates how the improved internal representation and consistency validation enable additional technical applications that depend on precise, machine-checkable topology information.

Through these embodiments and variations, the system realizes a specific technical implementation in which the server, the terminal, and the generative AI model cooperate to transform user-provided deployment information into validated, visual network configuration diagrams. The server improves the functioning of the overall computer system by orchestrating structured data storage, prompt sentence generation, model invocation, explanation analysis, graph-based internal representation, diagram data generation, and feedback-based correction, thereby providing technological improvements in processing speed, accuracy, resource utilization, and data management.

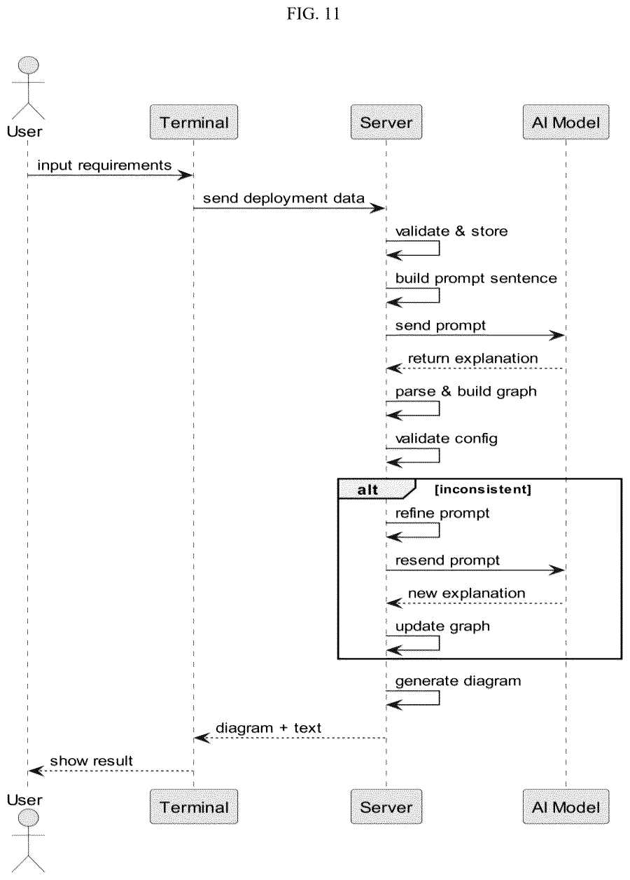

The following describes the processing flow using FIG. 11.

### Step 1

The user operates the terminal to open an application and input deployment information relating to communication equipment. The input includes, as an input data set, textual entries and selections such as device types, quantities, and site characteristics. The terminal receives this input data, validates that mandatory fields are filled, and converts the human-readable entries into an internal structured format, such as key-value pairs representing site name, number of users, device categories, and constraint flags. The terminal outputs this structured deployment information as a request message and transmits it to the server via a communication path.

### Step 2

The server receives the request message from the terminal as an input and parses the message to extract the structured deployment information. The server performs data validation and normalization, such as checking that device names match supported categories and converting synonymous labels into canonical device types. Based on this input, the server executes data operations that map text labels to internal identifiers and that compute derived attributes, such as total device counts or flags indicating whether redundancy is requested. The server outputs a cleaned and normalized structured data record and stores the record in an information management area of a storage device.

### Step 3

The server acquires the stored structured data record from the storage device as an input and prepares to generate a prompt sentence. The server analyzes the structured fields, such as usage site scale, number of users, reliability requirements, and security requirements, and applies rule-based processing to select and order relevant information. The server performs data concatenation and natural language templating operations to convert the structured fields into continuous text. As a result, the server outputs a prompt sentence in natural language that encodes the deployment constraints and device information as an instruction string for a generative AI model.

### Step 4

The server refines the prompt sentence using additional constraint extraction as an input to the refinement process. The server examines the normalized data to determine whether redundancy, segmentation, or specific security zones are required and performs conditional branching operations to decide which constraint phrases need to be appended. The server then updates the prompt sentence by inserting phrases such as “with high availability for Internet access” or “with separate segments for employees and guests.” The server outputs a finalized, constraint-rich prompt sentence that more precisely guides the generative AI model.

### Step 5

The server uses the finalized prompt sentence as an input to a communication module that interacts with the generative AI model. The server encapsulates the prompt sentence into a model request structure, sets model parameters such as maximum output length and temperature, and transmits the request to the generative AI model through an external interface. The generative AI model processes the prompt sentence internally and returns explanation information as an output, in the form of natural language text describing a network connection structure. The server receives this explanation information as the output of the remote computation and stores it temporarily in memory.

### Step 6

The server uses the explanation information as an input to an analysis module configured to produce an internal representation. The server performs text parsing and pattern matching operations, such as scanning for phrases that indicate device roles, upstream/downstream relations, and segmentation labels. The server converts the unstructured text into a structured graph by creating nodes for each communication device and edges for each described connection. The server attaches attributes to each node and edge, derived from the explanation information, such as security zone identifiers or VLAN numbers. The server outputs the internal representation as a graph data structure expressing the logical configuration of communication equipment and communication paths.

### Step 7

The server validates the internal representation using the original structured deployment data and predefined consistency rules as inputs. The server performs graph analysis operations to confirm that required devices are present, that connectivity exists between mandatory endpoints, and that segmentation constraints are satisfied. The server computes checks, such as reachability between subnets and presence of redundancy where required. If the server detects a configuration inconsistency as an output of these validation operations, the server generates an inconsistency report and sets a flag indicating that a revision of the prompt sentence is necessary.

### Step 8

The server, when the inconsistency flag is set, uses the inconsistency report and the original structured deployment data as inputs to a prompt modification module. The server determines, via rule-based logic, which additional instructions need to be included, such as “ensure at least two routers operate in a redundant pair” or “ensure all Internet-bound traffic traverses a firewall.” The server performs string manipulation operations to insert or replace clauses in the existing prompt sentence, thereby creating a modified prompt sentence that explicitly addresses the detected inconsistency. The server outputs this modified prompt sentence and, if necessary, repeats the interaction with the generative AI model by returning to the sending process, resulting in updated explanation information as a new output.

### Step 9

The server uses the validated internal representation as an input to a diagram generation module. The server calculates positions for nodes and routes for edges using a layout algorithm, such as a hierarchical layout that orders devices by their logical layer. The server transforms the graph structure into drawing description data by generating geometric coordinates, shapes, and labels corresponding to devices and links. The server then converts the drawing description data into image data, such as vector or raster graphics, using a rendering engine. The server outputs configuration diagram data in a format suitable for transmission to the terminal.

### Step 10

The server aggregates the configuration diagram data and the explanation information as inputs to a response generation process. The server constructs a response message that includes the generated image or drawing description and the descriptive text explaining the network configuration. The server performs data packaging and encoding operations to embed these elements into a communication message and transmits the response to the terminal over the communication path. The server outputs the completed response as the final result of the generation and validation pipeline for the current request.

### Step 11

The terminal receives the response message from the server as an input and decodes the contained configuration diagram data and explanation information. The terminal renders the image data or drawing description data on the display by drawing graphical elements representing devices and paths. The terminal also displays the explanation information in association with the diagram, for example as a text panel or tooltips. The terminal outputs a user interface that allows the user to visually inspect the recommended network configuration. The user, based on this output, may decide to confirm the design or to adjust deployment parameters and initiate a new cycle of processing by supplying revised input through the terminal.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional techniques for designing and operating communication networks in industrial environments rely heavily on human experts to interpret deployment status, traffic conditions, and device constraints, and to translate such information into network configuration diagrams and routing policies. In many cases, network deployment information is scattered across multiple management tools and static documents, and is not maintained in a machine-readable, up-to-date form suitable for automated reasoning. As a result, generating or updating a network configuration diagram, and deriving optimal communication paths between devices, typically requires manual aggregation of configuration data, ad hoc analysis of performance metrics, and manual editing of diagrams and configuration scripts.

Furthermore, existing systems that incorporate machine learning or automated design assistance generally treat network topology, traffic metrics, and device requirements as loosely coupled inputs, and provide only template-based or rule-based suggestions. These systems are often unable to dynamically construct rich prompt sentences that faithfully reflect current deployment status, time-varying communication quality, and detailed connection requirements, and then feed such structured prompts into a generative AI model in a consistent and automated manner. Consequently, the output of such systems is limited in accuracy and adaptability, and may not fully utilize the capabilities of generative AI models for complex network design tasks.

In addition, many network management tools focus on static configuration and do not provide an integrated mechanism for: (i) converting real-time deployment and performance data into structured graph data, (ii) computing a plurality of candidate communication paths and selecting optimal and alternative paths based on communication quality and constraints, and (iii) returning the result as visualization data that can be interactively explored by a non-expert user. Without such integration, it is difficult to continuously adapt the network configuration and routing to changing conditions, while still presenting the configuration in an understandable visual form.

Moreover, existing systems that offer natural language interfaces to network information generally provide only question-and-answer capabilities over static data, without tying the natural language interaction to the underlying generative design process. In particular, they often do not support acquiring user inquiries via a display device, embedding such inquiries into prompt sentences together with current network state, and using a generative AI model to produce consistent explanation information and concrete modification proposals that can be propagated back into the network configuration diagram and communication path computation pipeline.

Accordingly, there is a need for an improved computer-based technique that: (i) systematically stores and maintains deployment status information and device state information in a form suitable for generative processing; (ii) automatically generates structured data and prompt sentences that describe topology, communication quality, and connection requirements, and inputs them to a generative AI model; (iii) computes, from AI-generated configuration data and live communication quality information, graph data representing multiple candidate communication paths, and selects optimal and alternative paths; and (iv) outputs visualization data and interactive natural language explanations and modification proposals, thereby improving the functioning of the computer system itself in terms of automated network design, optimization, and human-computer interaction.

The specific processing by the specific processing unit 290 of the data processing device 12 in Application Example 1 is realized by the following means.

The present invention provides a server comprising a processor and a storage device, the processor being configured to store, in the storage device, deployment status information of a communication network and state information regarding connection target equipment; to generate, based on the deployment status information and the state information, structured data including topology information, communication quality information, and connection requirement conditions, and to create a prompt sentence including the structured data; to input the prompt sentence and the structured data to a generative AI model and cause the generative AI model to generate network configuration diagram data including elements of the communication network and connection relationships between pieces of equipment; to generate, based on the network configuration diagram data and the communication quality information, graph data representing a plurality of candidate communication paths between pieces of equipment and to calculate an optimal communication path and an alternative communication path; to output the network configuration diagram data and a calculation result regarding the communication paths as visualization data and to cause a display device to display a network configuration diagram including the pieces of equipment and the communication paths; and to acquire, via the display device, a natural language inquiry input by a user, to generate a prompt sentence including the inquiry, and to input the prompt sentence to the generative AI model to cause the generative AI model to generate explanation information or modification proposals regarding the network configuration diagram and the communication paths. This enables the computer system to internally transform heterogeneous deployment and performance data into machine-usable structured representations and AI-ready prompt sentences, to automatically synthesize network configuration diagrams and optimized communication paths using a generative AI model in combination with graph-based computation, and to provide interactive visualizations and natural language guidance that support continuous, data-driven reconfiguration of the communication network without requiring expert-level network design skills from the user.

The term “processor” refers to a hardware execution unit, such as a central processing unit or a processing circuit, that executes program instructions to perform data processing, control, and calculation operations in the system.

The term “storage device” refers to a hardware memory resource, such as a semiconductor memory, a magnetic storage medium, or an optical storage medium, that stores deployment status information, state information, structured data, and program code used by the processor.

The term “deployment status information” refers to information indicating how a communication network is currently installed and operated, including configuration of network devices, logical segmentation, addressing schemes, and operational parameters.

The term “state information regarding connection target equipment” refers to information indicating identification, capabilities, communication requirements, and current connection conditions of equipment intended to be connected to the communication network.

The term “structured data” refers to data organized according to a predetermined schema or format, such as a table, a record, or a hierarchical object, which includes topology information, communication quality information, and connection requirement conditions in a machine-readable form.

The term “topology information” refers to information describing nodes and links of a communication network, including device types, connection relationships, and structural arrangement of network elements.

The term “communication quality information” refers to information indicating performance characteristics of communication in the network, including latency, bandwidth, jitter, error rate, packet loss, and other quality-related metrics.

The term “connection requirement conditions” refers to constraints and requirements associated with communication for particular equipment or flows, including latency limits, bandwidth demands, redundancy levels, security constraints, and priority levels.

The term “prompt sentence” refers to a natural language or semi-structured text input that describes a task, context, and constraints, and that is supplied to a generative AI model to induce generation of a desired output.

The term “generative AI model” refers to a trained computational model, implemented in software and executed by the processor, that receives a prompt sentence and associated data and outputs generated content, such as textual descriptions, configuration proposals, or structured representations of a network configuration.

The term “network configuration diagram data” refers to data that represents components of a communication network and their interconnections, including device elements, link elements, and attributes of such elements, and that can be used to generate a visual diagram.

The term “elements of the communication network” refers to constituent components of a communication network, including network devices, communication links, and connected equipment that participate in data communication.

The term “connection relationships between pieces of equipment” refers to logical or physical associations indicating how equipment is linked to network devices and to other equipment for data communication.

The term “graph data” refers to data representing a graph structure, including nodes corresponding to equipment or network devices and edges corresponding to communication links or paths between the nodes.

The term “candidate communication paths” refers to a plurality of possible routes in the communication network over which data may be transmitted between pieces of equipment.

The term “optimal communication path” refers to a selected communication route between pieces of equipment that satisfies one or more optimization criteria, such as minimal latency, maximal available bandwidth, or improved reliability, among the candidate communication paths.

The term “alternative communication path” refers to a communication route, different from an optimal communication path, that is prepared as a secondary or backup route to be used when the optimal communication path is degraded or unavailable.

The term “visualization data” refers to data formatted to enable graphical rendering of a network configuration diagram and communication paths on a display device, including positional information, graphical attributes, and annotations.

The term “display device” refers to an output apparatus, such as a monitor, a touch panel, or another visual display unit, that presents graphical or textual information to a user.

The term “natural language inquiry” refers to a question or request expressed in a human language, such as English or another spoken language, provided by a user to obtain information or guidance from the system.

The term “explanation information” refers to generated content that describes reasons, rationale, or interpretation regarding a network configuration diagram, communication paths, or configuration decisions in a form understandable to a human user.

The term “modification proposals” refers to generated suggestions indicating changes or adjustments to a network configuration diagram, communication paths, or related settings in order to improve performance, adapt to new requirements, or address detected issues.

The term “setting information” refers to configuration parameters and values, including address assignment information, route control information, and quality control information, that are used to define operational behavior of network devices or connection target equipment.

The term “address assignment information” refers to information specifying allocation of network layer or link layer addresses, such as internet protocol addresses or hardware addresses, to devices or interfaces in the communication network.

The term “route control information” refers to information defining how packets or frames are forwarded through the communication network, including routing rules, path selection policies, and forwarding entries.

The term “quality control information” refers to information specifying quality of service or traffic management behavior, including priority settings, bandwidth guarantees, traffic shaping parameters, and congestion control policies.

The term “instruction information” refers to output data that indicates operations to be performed for configuring network devices or connection target equipment, including commands, configuration scripts, or step-by-step guidance for an operator.

The term “time-series information” refers to information collected or recorded with associated time points or intervals, representing temporal changes in deployment status information, communication quality information, or state information regarding connection target equipment.

The server, the terminal, and the user cooperate to implement embodiments of the invention as follows.

The server includes a processor, a main memory, a non-volatile storage device, a network interface, and, in some embodiments, a graphics processing unit. The server executes an operating system such as a general-purpose server operating system and middleware including a web application framework, a database management system, and a machine learning framework. The server stores program modules that implement: (i) deployment status management, (ii) structured data generation, (iii) prompt sentence generation, (iv) generative AI model inference, (v) graph-based communication path calculation, and (vi) visualization data generation and natural language explanation generation.

The terminal includes a processor, a memory, a display device such as a liquid crystal display or organic light emitting diode display, an input interface such as a keyboard or touch panel, and a network interface. The terminal executes a web browser or a dedicated client application. The terminal sends user input to the server via a communication network and displays visualization data and natural language responses received from the server.

The user operates the terminal to register connection target equipment such as machines, controllers, or sensors in an industrial facility, to review generated network configuration diagrams, to receive instructions for configuring network devices, and to submit natural language inquiries.

The server uses the storage device to maintain deployment status information of a communication network and state information regarding connection target equipment. The server stores, for example, a table of network devices (switches, routers, wireless access points, controllers), a table of physical links and logical segments (virtual networks, subnets, routing domains), a table of connection target equipment, and a table of communication performance metrics. Each table is stored in a relational or document-oriented database in a machine-readable, structured format. The server uses such data as a basis for data processing and data computation.

The server executes software, for example a web application running on a web framework, to receive state information regarding connection target equipment from the terminal. The state information includes identification data of the equipment, required latency, required bandwidth, redundancy requirements, and intended connection locations in the communication network. The server normalizes the received information into structured data. The server converts physical units into internal numeric representations, maps human-readable labels into numeric codes, and encodes connectivity constraints as attributes in a data structure such as a dictionary or a record. The server thus generates structured data that include topology information, communication quality information, and connection requirement conditions.

The server also maintains topology information representing nodes and links in the communication network as a graph structure. The server uses a graph library executed by the processor to represent network devices and equipment as nodes and communication links as edges with attributes such as bandwidth, current utilization, and error rate. The server periodically updates communication quality information by receiving measurement data from network devices and connection target equipment. The measurement data include latency, jitter, packet loss, throughput, and error counters. The server aggregates these measurements over time windows, derives summary statistics, and stores them as communication quality information. This data processing enables the server to compute candidate communication paths that reflect current communication quality.

The server generates a prompt sentence by embedding the structured data into a natural language template. The server constructs the prompt sentence such that it describes: (i) the deployment status of the communication network, (ii) the current communication quality, and (iii) the connection requirement conditions of target equipment. For example, the server may generate a prompt sentence such as:

“A new machine has been added to the factory communication network.

Current network deployment is as follows: multiple switches, routers, and wireless access points are connected in a hierarchical topology. Link utilization and latency metrics are available.

The new machine requires low-latency and high-reliability communication with the control server.

Based on this information, generate a detailed network configuration diagram, including connection relationships and settings, and propose optimal and alternative communication paths that satisfy the latency, bandwidth, and redundancy requirements.”

In another example, the server may generate a prompt sentence such as:

“A new robot arm has been installed. Its identifier is Robot_A_03, and it will be connected to an access switch at a specific port. The robot requires a maximum end-to-end latency of 5 milliseconds to the control system and high reliability.

Using the current network deployment and traffic status, generate a network configuration diagram and suggest optimal communication routes between the robot and the control system, including backup routes.”

In another example, the server may generate a prompt sentence such as:

“Traffic in Zone B has increased due to additional sensors. Current measurements show high utilization and increased latency on several links.

Update the network configuration diagram and recommend new communication paths that avoid congestion while maintaining stable performance for critical machines.”

The server inputs the prompt sentence and the structured data to a generative AI model. In one embodiment, the generative AI model is a transformer-based neural network trained to map descriptive prompt sentences and structured network state inputs to network configuration diagram data. The server executes the generative AI model using a machine learning framework such as a tensor computation library. The generative AI model has multiple layers of self-attention and feedforward units, and internal parameters are represented by weight matrices and bias vectors. The server supplies the prompt sentence as a sequence of token embeddings and supplies the structured data as additional embeddings or conditioning vectors. The generative AI model performs a sequence of matrix multiplications, non-linear activations, attention-weight computations, and normalization operations to predict output tokens or structured outputs that represent network configuration diagram data.

The server trains the generative AI model in advance using supervised learning on a dataset of network topologies, performance metrics, and expert-designed configuration diagrams and paths. The server defines an error function, such as a cross-entropy loss between predicted configuration tokens and reference configuration tokens, and uses an optimization algorithm such as stochastic gradient descent with momentum or adaptive learning rate methods to update weights. The server also may use data augmentation techniques, such as perturbing traffic metrics and randomly modifying topologies in non-destructive ways, to expose the model to a broader distribution of scenarios. Through such training, the generative AI model learns patterns between topology, communication quality, and configuration choices that are difficult to encode in hand-crafted rules.

The server uses the generative AI model not only as a text generator but as a structured decision engine. The server constrains model outputs to a predefined schema, for example a set of configuration operations or network element descriptors. The generative AI model outputs, as network configuration diagram data, a set of nodes representing devices and equipment, a set of edges representing connection relationships, and attributes such as logical segmentation identifiers, priority levels, and bandwidth reservations. The server parses this output into an internal graph representation.

The server performs additional data computation on the internal graph representation to calculate candidate communication paths and to select an optimal communication path and an alternative communication path. The server applies graph algorithms such as shortest-path algorithms and multi-constraint path selection algorithms. The server assigns edge weights derived from communication quality information, such as a weighted combination of latency, utilization, and error rate. The server calculates path scores based on these weights and connection requirement conditions such as maximum allowable latency and minimum bandwidth. The server selects a path that minimizes a cost function subject to constraints as the optimal communication path and selects one or more disjoint or partially disjoint paths as alternative communication paths.

The server thus combines the generative AI model, which suggests a topology-level design and configuration structure, with deterministic graph algorithms, which enforce quantitative optimization under measured performance metrics. This combination yields a technical effect: the server avoids suboptimal or inconsistent human-designed routes and instead computes consistently optimal or near-optimal communication paths that adapt to real-time quality metrics. Because the server encodes requirements and metrics directly into numerical weights and constraints, the path calculation can be repeated rapidly and consistently across large topologies, improving processing speed, accuracy, and reducing human error.

The server generates visualization data based on the network configuration diagram data and the calculated communication paths. The server assigns layout positions to nodes using layout algorithms such as force-directed placement or hierarchical layout, executed as numeric iterations over node coordinates until convergence. The server encodes node positions, connection lines, and stylistic attributes such as colors and line styles into visualization data that can be rendered by the terminal. For example, the server may use a vector graphics description where nodes and edges are expressed as objects with coordinates and visual properties. The server marks optimal communication paths in one color and alternative paths in another color. This technical structure allows the terminal to render complex networks efficiently, and the server can update only changed portions of the visualization, reducing communication and rendering load.

The terminal receives visualization data from the server and renders it on the display device. The terminal draws icons for network devices and equipment and lines for links and communication paths. The terminal overlays annotations such as latency, utilization, and assigned logical segmentation next to the paths. The terminal may allow the user to interactively select nodes or paths, in which case the terminal sends user selections back to the server for further processing.

The user reviews the network configuration diagram and the listed communication paths on the terminal. The user can see concrete instructions for configuring network devices, such as which ports to use and which segmentation identifiers or priority settings to assign. The user can then physically connect cables, configure switches and routers, and activate communication according to the guidance. By following configuration instructions derived from optimized path calculations and AI-generated configuration proposals, the user can achieve network configurations that are more efficient and robust than those designed manually.

The server also supports natural language queries from the user via the terminal. The user inputs questions such as “Why did you choose this path instead of that path?” or “How should I modify the configuration if latency increases in this zone?” The terminal sends the natural language inquiry to the server. The server constructs a prompt sentence that includes the inquiry and the current network state and passes it to the generative AI model. The generative AI model uses internal attention and context mechanisms to produce explanation information or modification proposals. The server then translates such proposals into concrete configuration changes or updated path calculations, if appropriate, and returns both textual explanations and updated visualization data to the terminal. In this way, the generative AI model is not merely a conversational interface but is deeply integrated into the configuration generation and path optimization pipeline.

The server improves computer technology in several ways. First, by storing deployment status information and performance metrics in structured form and by automatically transforming them into prompt sentences and machine-readable structured data, the server enables the generative AI model to operate on rich, up-to-date context, which reduces the need for manual aggregation and interpretation of data. This leads to improved data management and reduced inconsistency between documentation and actual network state. Second, by integrating structured outputs of the generative AI model with graph-based optimization algorithms, the server uses computational resources to perform complex, multi-constraint path optimization that would be infeasible or error-prone for human operators, thus achieving more accurate and faster route selection. Third, by generating visualization data that correspond directly to optimized configuration diagrams and paths, the server allows incremental updates and efficient rendering, thereby reducing communication load and rendering computation at the terminal.

The server further improves technical performance through the architecture and training of the generative AI model. The server uses specific input encodings where topology, metrics, and requirements are embedded into vector spaces that capture relevant features such as connectivity patterns, bottleneck likelihood, and sensitivity to latency. During training, the server can use loss functions that penalize generated configurations that violate constraints or produce inefficient paths. For example, the server can augment cross-entropy loss with constraint violation penalties computed from simulated path computations. This encourages the generative AI model to generate configurations that are more compatible with subsequent deterministic optimization algorithms, resulting in fewer iterations and lower computational cost during inference time.

The server employs non-conventional processing order and rules within the generative AI model pipeline. Rather than directly mapping textual descriptions to high-level suggestions, the server enforces a two-stage internal representation: a latent structural representation of the network followed by a partial configuration representation. This internal structure is used by deterministic graph algorithms. Thus, AI processing is not a mere automation of human design steps but a reorganization of representations and calculations in a form that is specifically tailored for efficient machine processing and optimization. The causality between these processes and the resulting technical effects is as follows: constrained generative output reduces the search space for path optimization, lowering computation time; explicit encoding of performance metrics into attention inputs improves the alignment between generated configurations and real network conditions, reducing misconfiguration errors and improving robustness.

The server may apply multiple embodiments for the generative AI model and associated algorithms. In one embodiment, the generative AI model is a transformer with encoder-decoder architecture, where the encoder processes structured graph data and metrics, and the decoder generates configuration tokens guided by attention over the encoder output. In another embodiment, the server uses a graph neural network component to encode topology and link attributes as node embeddings before feeding them into a transformer decoder. In yet another embodiment, the server uses a hybrid system where a generative model proposes an initial configuration that is refined by a heuristic rule-based module, and results are re-evaluated using a cost function that relates to link load and latency.

The server also may implement alternative algorithms for candidate path computation, such as k-shortest-path algorithms or constrained path search methods using dynamic programming. The server may adapt edge weights over time based on observed performance statistics, with learning rules that adjust weight coefficients when repeated deviations from expected performance are detected. This adaptive weighting mechanism enables the system to improve over time without retraining the entire generative AI model, thereby providing an incremental learning capability within the path optimization layer.

The terminal, in some embodiments, executes a lightweight client application that caches recent visualization data and user interaction histories. The terminal can request partial updates from the server when small changes in configuration occur. This reduces network traffic and accelerates visualization updates, contributing to reduced communication overhead and improved user experience.

The user can deploy this system in various environments, such as industrial plants, data centers, or large office networks, where rapid changes in topology and load require frequent reconfiguration. The user can rely on the server's ability to integrate generative AI with structured graph-based computation to produce reliable, optimized network configurations that respond to real-time conditions. The user thus benefits from improved performance, reduced downtime due to misconfigurations, and lower expertise requirements, while the underlying computer system performs technically sophisticated processing beyond simple task automation.

The embodiments described above are examples, and the server, the terminal, and the user can adopt various modifications, such as different database schemas, different neural network architectures, or different cost functions and constraints, while still falling within the technical scope supported by the claims.

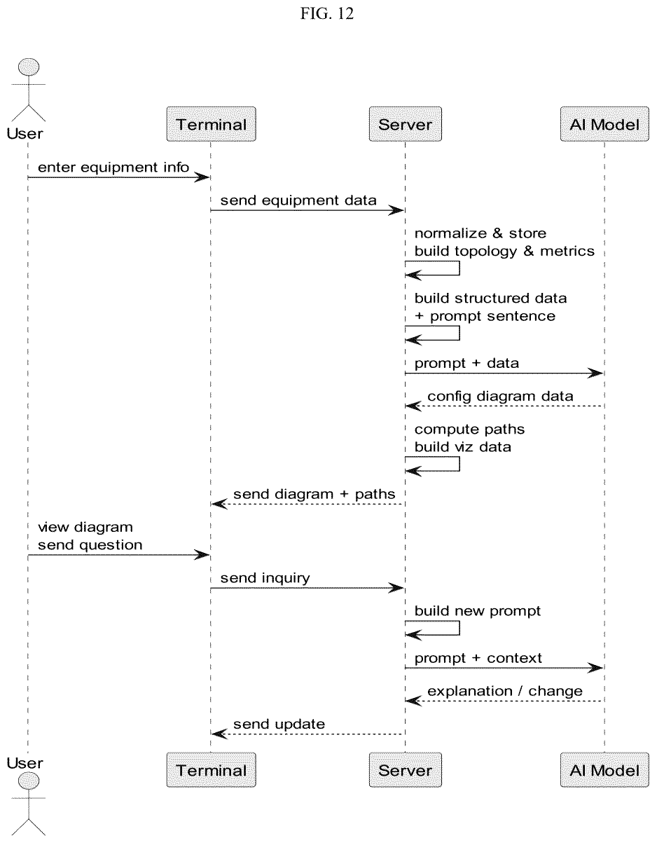

The following describes the processing flow using FIG. 12.

### Step 1

The user operates the terminal to input equipment information and network requirements. The user opens an application screen on the terminal and enters, as input, attributes of connection target equipment, such as an equipment identifier, equipment type, required latency, required bandwidth, redundancy level, and intended connection location in the communication network. The terminal performs local validation on the input data, such as checking for missing fields and verifying that numeric values fall within allowable ranges. The terminal then converts the validated input into a structured request format and outputs the request as a message addressed to the server via a communication network.

### Step 2

The server receives, as input, the equipment information and network requirements transmitted by the terminal. The server parses the received message, extracts fields such as identifiers, performance requirements, and candidate connection points, and stores the raw data in a database as records. The server performs data processing by normalizing units (for example, converting latency strings into numeric milliseconds), mapping equipment types and redundancy levels into internal codes, and resolving logical names of network devices into internal identifiers. The server outputs normalized state information and requirement information as structured data objects to be used in subsequent processing.

### Step 3

The server accesses, as input, the stored deployment status information of the communication network and the normalized state information of the connection target equipment. The server queries database tables containing network devices, links, logical segments, and previously registered equipment, and combines these results with the newly normalized data. The server constructs topology information by representing each network device and equipment as a node and each physical or logical link as an edge. The server outputs an initial graph structure that encodes connectivity and attributes such as link capacities and device roles.

### Step 4

The server collects, as input, communication measurement data from network devices and sensors attached to equipment. The server receives periodic reports containing metrics such as latency, jitter, throughput, and error counts, and stores them in a time-series database. The server performs data processing on these time-series records by aggregating metrics over predetermined time windows, computing averages, percentiles, and variability, and detecting links with unusually high utilization or error rates. The server outputs communication quality information by annotating the previously generated graph structure with performance attributes, such as current latency and utilization for each link.

### Step 5

The server receives, as input, the topology information, the communication quality information, and the connection requirement conditions of the equipment. The server generates a structured representation that integrates these data, including lists of nodes and edges, per-link performance metrics, and per-equipment constraints. The server then creates a prompt sentence by embedding key elements of the structured representation into a natural language template. During this data processing, the server converts numerical constraints (for example, a maximum latency value) into descriptive phrases and formats device and link identifiers into human-readable descriptions. The server outputs both a prompt sentence that describes the design task and a structured data object that encodes the same context in machine-readable form.

### Step 6

The server provides, as input, the prompt sentence and the structured data to a generative AI model implemented as a trained neural network. The server converts the prompt sentence into token embeddings and encodes the structured data into additional conditioning vectors. The server executes the generative AI model by performing a sequence of numerical operations, including matrix multiplications, non-linear activation functions, attention weight calculations, and normalization across multiple network layers. Based on these numerical computations, the server obtains, as output, network configuration diagram data that specify nodes, connection relationships, segmentation identifiers, and preliminary communication route suggestions. The server parses this output into an internal configuration representation suitable for further algorithmic processing.

### Step 7

The server accepts, as input, the network configuration diagram data generated by the generative AI model and the previously annotated graph containing communication quality information. The server constructs a refined graph data structure in which each node and edge includes attributes from both the AI-generated configuration and the measured performance metrics. The server performs data computation by assigning weights to edges based on a function of latency, utilization, error rate, and required redundancy. Using graph algorithms, the server calculates multiple candidate communication paths between the connection target equipment and one or more destination nodes such as control systems or servers. The server outputs a list of candidate paths along with associated cost values and constraint satisfaction indicators.

### Step 8

The server receives, as input, the candidate communication paths and their computed cost values. The server selects an optimal communication path by evaluating a cost function that may weight latency, bandwidth, reliability, and hop count according to the connection requirement conditions. The server then identifies at least one alternative communication path that is topologically distinct or less correlated in failure risk. The server performs data computation by ranking paths, verifying that they satisfy predefined constraints, and filtering out infeasible or redundant paths. The server outputs final path selections, including a designated optimal path and one or more alternative paths associated with each communication flow.

### Step 9

The server takes, as input, the refined configuration diagram data and the selected optimal and alternative communication paths. The server executes a layout algorithm that iteratively updates node positions and edge routing coordinates to minimize visual overlap and improve diagram readability. During this processing, the server assigns visual attributes such as colors and line styles to distinguish different device types and to highlight optimal and alternative paths. The server outputs visualization data, including node positions, link shapes, and annotation positions, encoded in a format suitable for rendering by the terminal.

### Step 10

The terminal receives, as input, the visualization data and path selections transmitted by the server. The terminal parses the received data and draws, on the display device, a network configuration diagram with nodes representing equipment and network devices and lines representing communication links and paths. The terminal overlays labels showing identifiers, performance metrics, and assigned segmentation or priority information. The terminal outputs a graphical user interface that presents the network configuration in a form that the user can inspect and manipulate.

### Step 11

The user observes, as input, the rendered network configuration diagram and the displayed information on the terminal. The user interprets the recommended connection points, communication paths, and settings such as addressing schemes and quality control parameters. Based on this visual and textual guidance, the user performs physical and logical configuration of network devices and connections in the real environment, such as connecting cables to specific ports and applying the suggested configuration parameters via device management interfaces. The user outputs confirmation of completion to the server through an operation on the terminal if required.

### Step 12

The user inputs, as input, natural language inquiries into an interface displayed on the terminal, such as questions regarding the reasoning behind a chosen communication path or requests for reconfiguration under changed conditions. The terminal sends the inquiries to the server. The server receives the inquiries, combines them with current network state data, and constructs a new prompt sentence that embeds the inquiry in context. The server then performs data processing by formatting this combined information into a new prompt sentence and associated structured data. The server outputs the prompt sentence and context as input to the generative AI model.

### Step 13

The server inputs, as input, the context-rich prompt sentence generated in response to the user inquiry and the corresponding structured data into the generative AI model. The server causes the generative AI model to perform additional inference, executing numerical computations across its internal layers to produce explanation information or modification proposals. The server parses the generated content, converts configuration-related suggestions into updated configuration data or path constraints, and recalculates paths if necessary. The server outputs both textual explanations that answer the user's inquiry and updated visualization data reflecting any accepted modifications, allowing the terminal to present refined diagrams and guidance to the user.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional techniques for designing communication system topologies and generating corresponding configuration diagrams rely heavily on manual work by human experts. A human operator is typically required to collect deployment state information of communication resources, such as device types, quantities, and installation locations, and then translate this information into a consistent logical and physical topology. This manual procedure often involves repeated trial-and-error, results in inconsistent documentation, and imposes a high cognitive load on the operator, especially when design constraints such as address assignment, routing policies, and segmentation rules must be carefully coordinated.

Even where general-purpose generative AI models are available, they are not directly integrated into a structured design workflow. In particular, conventional systems do not automatically transform raw deployment state information stored in a data store into well-formed prompt sentences tailored for a generative AI model, do not persistently manage iterative user corrections as structured history, and do not feed such history back into dynamic adjustment of subsequent prompt sentences. As a consequence, the behavior of the generative AI model remains largely opaque and non-deterministic from the perspective of the system, and repeated design iterations frequently produce inconsistent or suboptimal configuration diagrams.

Moreover, existing tools typically treat the network diagram as a static output artifact. They do not provide a closed feedback loop in which user corrections applied to a displayed configuration diagram are reflected back into underlying deployment state information and into the structure of future prompt sentences. Without such a loop, the system cannot learn from prior revisions, cannot systematically encode design preferences, and cannot progressively converge toward designs that better match the operational environment and constraints.

Further, conventional configuration diagram generators rarely generate explanation information regarding logical connection configurations and address schemes in a machine-mediated manner. Human operators must manually infer or document details such as communication identifier assignment, route selection, and segmentation policies, which increases the risk of configuration drift between the documented design and the deployed system.

Accordingly, there is a need for an improved computer-implemented system that (i) automatically stores and structures deployment state information of communication resources, (ii) programmatically constructs and updates prompt sentences for a generative AI model based on such information and user edit histories, (iii) transforms generative AI outputs into consistent visualization data for configuration diagrams, and (iv) iteratively refines both the underlying data and the prompt construction logic in response to user interaction. Such a system would improve the functioning of the computer itself by enabling more efficient, accurate, and repeatable generation of network configuration diagrams and associated explanation information.

The specific processing by the specific processing unit 290 of the data processing device 12 in Example 2 is realized by the following means.

The present invention provides a server comprising a processor and a storage device, the processor being configured to receive deployment state information of communication resources from an external input/output device and store the deployment state information as structured information in the storage device, to aggregate, based on the deployment state information stored in the storage device, types, quantities, installation locations, and requirement specifications of the communication resources and construct, in a natural language, a prompt sentence to be used as input to a generative AI model, to transmit the prompt sentence to the generative AI model via a communication interface and generate configuration information representing connection relationships among the communication resources based on output information acquired from the generative AI model, to convert the configuration information into visualization data and generate output information that is presentable as a configuration diagram of a communication system on a display device, and to reflect, in the deployment state information or in the prompt sentence, correction instructions for the configuration diagram received from a user via the display device and update the prompt sentence for re-input to the generative AI model. This enables the computer system to automatically transform structured deployment state information and iterative user feedback into optimized prompt sentences for the generative AI model, thereby generating and refining communication system configuration diagrams and associated explanation information in a consistent, repeatable, and computationally efficient manner.

The term “system” refers to a combination of hardware and software components that cooperate to execute one or more functions, including at least a processor, a storage device, and a communication interface.

The term “processor” refers to one or more hardware-based information processing units, such as a central processing unit or a microcontroller, configured to execute stored instructions to perform logical operations, arithmetic operations, control operations, and data processing operations.

The term “storage device” refers to any non-transitory computer-readable medium capable of storing data and program instructions, including, for example, semiconductor memory, magnetic storage, or optical storage.

The term “external input/output device” refers to any terminal apparatus or user interface device, such as a client computing device, that is configured to transmit data to or receive data from the system via a communication path.

The term “deployment state information” refers to data representing a current or planned installation status of communication resources, including at least types, quantities, physical locations, and operational attributes of the communication resources.

The term “communication resource” refers to any physical or logical component used to implement communication functionality in a communication system, including, for example, transmission apparatus, switching apparatus, routing apparatus, access apparatus, or related auxiliary apparatus.

The term “structured information” refers to data that is organized according to a predefined schema or data model, such as a set of records, fields, and data types, enabling programmatic storage, retrieval, and processing by the system.

The term “requirement specification” refers to information indicating desired properties or constraints of a communication system, including, for example, performance requirements, redundancy requirements, segmentation rules, and address allocation policies.

The term “natural language” refers to a human language, such as English, that is used for expressing instructions or descriptions in a form interpretable by human users and by natural language processing algorithms.

The term “prompt sentence” refers to a natural-language expression or set of expressions that encodes deployment state information and requirement specifications and is supplied as input to a generative AI model to control the content or style of generated output.

The term “generative AI model” refers to a parameterized information processing model, such as a neural network model, trained to generate text or other data in response to an input sequence, including but not limited to models configured for natural language generation.

The term “communication unit” refers to hardware and software elements that provide data transmission and reception functions between the system and external devices or services, including at least a network interface and a communication protocol stack.

The term “output information” refers to data generated by the system for presentation or further processing, including but not limited to configuration information, visualization data, and textual explanation information.

The term “configuration information” refers to data that represents logical or physical relationships among communication resources, including, for example, connection relationships, hierarchy structures, and association with communication parameters.

The term “visualization data” refers to data in a format suitable for graphical rendering of configuration information, such as node and link definitions, coordinates, labels, and style attributes used to generate a configuration diagram.

The term “configuration diagram” refers to a graphical representation of a communication system, showing at least communication resources as elements and connection relationships among the communication resources as links.

The term “display device” refers to any visual output apparatus capable of presenting graphical or textual information to a user, including, for example, a monitor, a touch panel, or a display unit of a terminal.

The term “user” refers to a human operator or entity that interacts with the system via an external input/output device to provide deployment state information, requirements, and correction instructions, and to view output information.

The term “correction instruction” refers to user-provided input indicating a modification, addition, or deletion with respect to a generated configuration diagram, configuration information, or associated requirement specifications.

The term “communication identifier” refers to a value used to distinguish communication entities or communication flows in a communication system, including, for example, network addresses, port numbers, or segment identifiers.

The term “route selection” refers to a process or rule set for determining a communication path or sequence of communication resources through which data is transferred between endpoints.

The term “segmentation” refers to logical separation of communication entities or communication traffic into distinct groups or domains, such as virtual local networks, security zones, or address domains.

The term “logical connection configuration” refers to an arrangement of logical relationships among communication resources, including logical links, communication paths, and grouping or layering of communication functions, independent of specific physical cabling.

The term “address scheme” refers to a systematic plan or rule set for assigning and organizing communication identifiers, such as network addresses and subnetwork ranges, in a communication system.

The term “update history” refers to recorded information indicating chronological changes applied to deployment state information, including at least timestamps, modified items, and modification contents.

The term “correction instruction history” refers to recorded information representing a sequence of correction instructions provided by the user over time, including, for example, identifiers of affected elements and requested modifications.

The term “dynamic adjustment” refers to an automatic modification of content or parameters performed by the processor at runtime in response to analysis of data, without requiring explicit manual rewriting of program instructions.

The term “content of the prompt sentence” refers to a specific wording, structure, and included parameter set in the prompt sentence that collectively define how deployment state information and requirement specifications are presented to the generative AI model.

The term “requirement condition” refers to a declarative constraint or goal included in the prompt sentence that specifies how the generative AI model should generate or refine configuration information, such as conditions for redundancy, security, or scalability.

In one embodiment, a server cooperates with one or more terminals operated by a user to generate and refine configuration diagrams for a communication system. The server includes at least a processor, a main memory, a non-transitory storage device, and a network interface. The terminal includes at least a processor, a memory, a display device, an input device such as a keyboard or pointing device, and a communication interface. The user operates a web browser or dedicated client application on the terminal to interact with the server.

The server executes an application program stored in the storage device. The application program is implemented, for example, using a server-side framework such as a generic web application framework, and the storage device is implemented, for example, using a relational database management system such as a relational database product. The terminal executes client-side software, such as a web browser implementing HTML, CSS, and JavaScript, or an equivalent client framework. The server and the terminal communicate over a packet-based communication network using secure transport protocols.

The server stores deployment state information of communication resources in the relational database. The deployment state information is represented as structured records in multiple tables. For example, a “device” table may include fields for a resource identifier, a resource type (e.g., router, switch, access point), a model identifier, a manufacturer identifier, a quantity, and a status. A “location” table may include fields for a building identifier, floor, room, rack position, and environmental constraints. A “requirement” table may include fields for performance targets, redundancy levels, segmentation policies, and address allocation preferences. The server associates these tables with a request identifier and a user identifier, forming a data structure that expresses the deployment state information as structured information.

The terminal presents input forms to the user via the display device. The user inputs communication resource information such as “one core router,” “three distribution switches,” “twenty access points,” installation floors, rooms, and required segmentation policies for office traffic and guest traffic. The terminal validates the format of user input using client-side logic and transmits the validated data to the server using a structured data format. The server parses the received data and converts it into the database records described above. By using normalized table schemas and structured fields, the server reduces redundancy and enables consistent retrieval and aggregation of deployment state information, thereby improving data management inside the computer system.

The server generates a prompt sentence for a generative AI model based on the deployment state information stored in the database. The server retrieves device records, location records, and requirement records using database queries that join the tables on the request identifier. The server aggregates the retrieved data by, for example, grouping devices by floor, summing quantities per device type, and deriving logical segments from requirement entries. The server then converts these aggregates into natural language fragments. For example, if the database holds three switches on a third floor and two switches on a fourth floor, the server constructs fragments such as “three access switches on the third floor” and “two access switches on the fourth floor.”

The server concatenates the fragments into a coherent prompt sentence that instructs the generative AI model how to generate network configuration information. For example, the server constructs a prompt sentence in the following format:

“Based on the following deployment state information, create an optimal communication network configuration diagram and describe the logical connection configuration and address scheme.
Core router: quantity 1, installed in the main equipment room on the 2nd floor.
Distribution switches: quantity 3, installed across the 3rd and 4th floors.
Access points: quantity 20, distributed evenly across floors 2 to 5.
Requirements: separate office traffic and guest traffic into different segments, assign appropriate communication identifiers, and select routes to provide redundancy between the core router and distribution switches.

Output the configuration in natural language and provide a list of logical connections and address ranges.”

In another example, the server constructs a prompt sentence for a revision:

“Based on the previous configuration diagram you generated, revise the communication network configuration so that an additional distribution switch is installed on the 3rd floor and guest traffic is moved into a dedicated isolated segment.

Clearly identify new logical connections and updated address assignments, and keep the existing device models and installation locations unchanged where possible.”

The server transmits the prompt sentence to a generative AI model executed on dedicated computation hardware. In one embodiment, the generative AI model is implemented as a multi-layer neural network, such as a transformer-based architecture. The model may include an input embedding layer that converts tokens of the prompt sentence into high-dimensional vectors, a plurality of self-attention layers that process contextual relationships among tokens, feed-forward sublayers, and an output projection layer that maps internal representations to probability distributions over possible next tokens.

The server transmits the prompt sentence as a token sequence to the generative AI model, along with control parameters such as maximum output length, sampling temperature, and a constraint mask. The generative AI model performs internal linear algebra operations, including matrix multiplications of embeddings with learned weight matrices, computation of attention scores using scaled dot products, application of non-linear activation functions, and normalization of intermediate representations. The model computes, at each time step, a probability distribution over the vocabulary space and selects the next token according to the specified sampling strategy. By repeating this process, the model outputs a sequence of tokens that form a natural language description of the recommended configuration, optionally interleaved with structured markers describing logical nodes and links.

The server uses this type of neural architecture because it can maintain long-range dependencies within the prompt sentence, allowing the model to coordinate address schemes, segmentation policies, and physical locations in a way that conventional rule-based systems cannot easily achieve. In addition, because the server supplies the deployment state information in a structured and aggregated manner, the generative AI model can focus on optimization of the logical configuration instead of inferring basic parameters, thereby improving computational efficiency and reducing unnecessary inference steps.

The generative AI model is trained, prior to deployment, using a dataset of network configurations, textual descriptions, and associated constraints. During training, an optimization algorithm such as stochastic gradient descent or a variant thereof updates the model's weight parameters to minimize a loss function, for example, cross-entropy between the model's token predictions and reference tokens. The training process includes backpropagation of gradients through attention layers and feed-forward layers, and may include regularization techniques such as dropout and weight decay to prevent overfitting. By training on diverse communication system topologies and address plans, the model acquires an ability to generate coherent configurations from varied deployment state information.

The server may further apply a post-processing algorithm to the output produced by the generative AI model. For example, the server parses the generated text to identify explicit references to device types, segments, address ranges, and link relationships. The server may use pattern-matching logic, such as regular expressions or finite-state machines, to extract entities like “core_router_1,” “VLAN 10 for office,” “subnet 192.168.10.0/24,” and “link between core_router_1 and switch_3.” The server then constructs a graph data structure in memory, where nodes represent communication resources and edges represent logical or physical links. Each node may store attributes such as resource type, floor, role, and assigned communication identifiers. Each edge may store attributes such as link capacity, redundancy role, and associated segment.

The server converts the graph data structure into visualization data, for example, into a vector graphics representation. The server may map each node to a coordinate in a two-dimensional plane using a layout algorithm, such as a force-directed layout or a layered graph layout. In a force-directed layout, the server models nodes as particles repelling each other and edges as springs that attract connected nodes, and iteratively updates node positions to minimize an energy function. This algorithm enables the server to automatically arrange nodes in positions that reduce edge crossings and improve readability, which is a technical improvement over naive grid placements that may cause visual clutter.

The terminal receives the visualization data and displays the configuration diagram on the display device. The user can visually inspect the diagram and may select nodes or edges to view detailed attributes. For example, when the user selects a node representing a switch on the third floor, the terminal may display a panel including the assigned communication identifiers, connected segments, and associated addresses. The user may also issue correction instructions through graphical operations, such as dragging a device from one floor region to another, or through textual commands entered in a side panel.

The server receives the correction instructions from the terminal and converts them into updates to the deployment state information stored in the database. For example, if the user moves a distribution switch from the third floor to the fourth floor, the server updates the location field of the corresponding device record. If the user requests an additional segment for guest traffic, the server inserts a new requirement record specifying segmentation type and desired isolation level. The server also records an update history entry, including a timestamp, a user identifier, and a description of the modification. By maintaining a structured update history, the server is able to analyze recurrent patterns in user corrections and improve future prompt sentence construction.

The server may analyze the update history using statistical methods. For example, the server may count how often users modify segments to isolate guest traffic and detect that such corrections occur frequently. In response, the server may dynamically adjust the content of the prompt sentence by automatically including a clause requesting isolation of guest traffic whenever deployment state information indicates the presence of public wireless access points. This dynamic adjustment is implemented by a rule engine that inspects the update history and requirement records and modifies template text used for prompt generation. Such an adjustment improves the accuracy and relevance of the generative AI model's outputs over time, thereby reducing the number of manual corrections required and improving the computational efficiency of the overall system.

In addition, the server may incorporate a feedback-driven weighting mechanism. The server may store scores representing user satisfaction or acceptance of generated configurations, such as flags indicating whether a configuration was finalized without further revision. The server may then use these scores to adjust parameters of the prompt sentence, for example, specifying stricter constraints on redundancy if prior configurations were frequently revised to add redundant links. This yields a form of closed-loop optimization where the server continuously tunes the prompt sentence to guide the generative AI model toward outputs that better match user preferences and operational policies.

The server is configured to include, in the prompt sentence, explicit conditions for communication identifier assignment, route selection, and segmentation. By doing so, the generative AI model produces not only a configuration diagram description but also detailed explanation information regarding logical connection configurations and address schemes. This explanation information may be parsed and mapped back into structured fields in the database. As a result, the server maintains a synchronized view between the graphical diagram, textual description, and underlying database records. This synchronization prevents configuration drift and reduces errors arising from inconsistent documentation.

The system produces technical effects beyond mere automation of human design work. First, by encoding deployment state information as structured records and by programmatically generating prompt sentences that tightly constrain the generative AI model's behavior, the server reduces the entropy of the model's search space, thereby reducing inference time and improving output consistency. Second, by converting model outputs into graph data structures and applying algorithmic layout methods, the server improves the readability of diagrams and reduces the cognitive load required for human verification. Third, by maintaining and analyzing detailed update histories and using them to dynamically adjust prompt sentences, the server improves the precision of subsequent configurations and reduces the number of iterations needed to reach a final design. These effects manifest as concrete improvements in processing speed, output accuracy, and data management efficiency in the computing system.

In another embodiment, the server may use different generative AI models or hybrid architectures. For example, the server may employ a generative model specialized in text generation to produce descriptive explanations and a separate model specialized in structured topology generation to output a machine-readable graph specification. The server may feed the output of the first model into the second model, or vice versa, by constructing intermediate prompt sentences that reference logical components identified by the other model. Such an arrangement further modularizes the computation and enables reuse of specialized models.

In yet another embodiment, the server may run an on-premise generative AI model instead of sending the prompt sentence to a remote service. In such a case, the server stores the model's parameters locally in the storage device and loads them into memory at runtime. The server executes matrix multiplications and other tensor operations on a hardware accelerator, such as a graphics processing unit, using a numerical computation library. The server thereby reduces network latency and preserves confidentiality of deployment state information, while still leveraging the generative capabilities of the AI model.

The terminal may vary as well. In one variation, the terminal is a handheld device with a touch-sensitive display. The user can manipulate nodes and links directly with finger gestures, and the terminal sends the gestures as structured correction instructions to the server. In another variation, the terminal is an engineering workstation that integrates with other design tools. The server exports the graph data structure in a format consumable by configuration deployment systems, enabling end-to-end automation from design to deployment.

Through these embodiments, the server, the terminal, and the user cooperate to implement a system in which deployment state information is structured, prompt sentences are systematically constructed and refined, generative AI outputs are transformed into graph structures and visualization data, and user feedback is closed-loop integrated into subsequent computations. This cooperation results in improvements to computer technology itself, including more efficient data storage and retrieval, more deterministic behavior of complex generative models, reduced network communication overhead due to fewer design iterations, and more accurate alignment between stored configuration data and real-world communication resources.

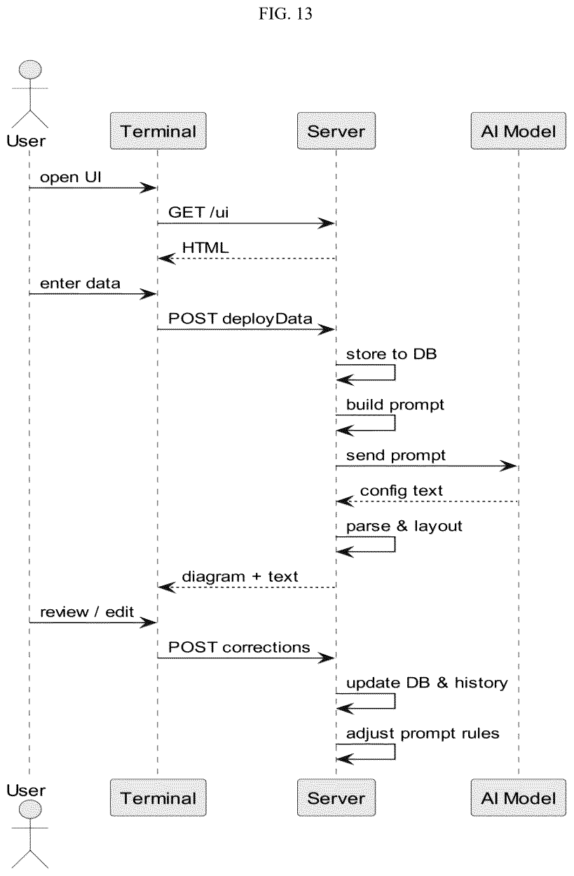

The following describes the processing flow using FIG. 13.

### Step 1

The user operates a terminal and opens a web browser or client application to access a user interface provided by the server. The input to this step is a URL or application entry point specified by the user. The terminal sends an HTTP request to the server, and the server returns HTML, CSS, and JavaScript resources. The output of this step is a rendered input screen on the terminal that allows the user to enter deployment state information for communication resources.

### Step 2

The user inputs communication resource information into form fields displayed on the terminal. The input to this step is the user's operational intent, such as planned devices, locations, and requirements, which the user expresses as text entries and selections. The terminal records device types, model identifiers, quantities, installation floors, rooms, and requirement items (for example, segmentation rules and redundancy preferences). The output of this step is a set of raw input values held in the terminal's memory.

### Step 3

The terminal performs client-side validation of the raw input values. The input to this step is the set of raw input values from the user. The terminal executes validation logic implemented in JavaScript to check data types (for example, ensuring that quantities are integers), mandatory fields, and value ranges (for example, number of floors). The terminal displays error messages near invalid fields when inconsistencies are detected. The output of this step is a corrected and validated set of input values or, in the case of errors, a revised set of input values after the user has made corrections.

### Step 4

The terminal serializes the validated input values into a structured data format and transmits them to the server. The input to this step is the validated set of input values. The terminal converts the values into a structured representation such as a JSON object, including keys for device type, location, and requirement category. The terminal sends this data in the body of an HTTP POST request over a secure communication channel. The output of this step is a structured request payload delivered to the server's application interface.

### Step 5

The server receives the structured request payload and parses it into internal data structures. The input to this step is the HTTP POST request containing the structured data from the terminal. The server uses a web application framework to parse the request body and map JSON keys to internal variables or objects, such as device records and requirement records. The server verifies that necessary fields are present and may perform additional server-side validation checks. The output of this step is an in-memory representation of deployment state information structured as device objects, location objects, and requirement objects.

### Step 6

The server stores the deployment state information in a relational database. The input to this step is the in-memory representation of devices, locations, and requirements. The server opens a database connection, constructs SQL insert or update statements, and writes the normalized data into relational tables, such as a device table, a location table, and a requirement table. The server also generates and assigns a request identifier and associates it with the stored records. The output of this step is a set of committed database records that persistently represent the deployment state information and an associated request identifier.

### Step 7

The server aggregates the stored deployment state information to prepare for prompt sentence construction. The input to this step is the set of database records identified by the request identifier. The server executes SQL queries that join device, location, and requirement tables, groups devices by floor and type, and computes summary values such as total count per device type or per floor. The server may also derive implicit requirements, such as default segmentation for guest networks when certain device types are present. The output of this step is a collection of aggregated values and derived attributes, organized in intermediate data structures in memory.

### Step 8

The server constructs a prompt sentence for the generative AI model using the aggregated values. The input to this step is the collection of aggregated values and derived attributes. The server selects template phrases from a prompt template store and fills variable segments with concrete values, such as the number of devices, floors, and segmentation requirements. The server concatenates these phrases into one or more coherent paragraphs that specify the design task, constraints, and desired output format. The output of this step is a natural-language prompt sentence that encodes the deployment state information and requirement specifications.

### Step 9

The server prepares a generative AI model request using the prompt sentence. The input to this step is the constructed prompt sentence. The server creates a request object that includes the prompt sentence, model identifier, and generation parameters, such as maximum token count and temperature. The server formats this object according to the generative AI model's API specification. The output of this step is a formatted generative AI model request ready for transmission.

### Step 10

The server transmits the generative AI model request and receives a generated response. The input to this step is the formatted request containing the prompt sentence and parameters. The server uses an HTTP client library to send the request over a secure network connection to a generative AI model endpoint. The generative AI model processes the prompt sentence internally, performing token embedding, attention-based transformations, and probability computations to generate a token sequence representing configuration instructions and explanations. The server receives the model's response as a JSON payload or equivalent data structure. The output of this step is an AI-generated text sequence that describes a recommended communication system configuration, and optionally a structured representation of nodes, links, and address ranges.

### Step 11

The server parses the AI-generated response into structured configuration information. The input to this step is the AI-generated text and optional structured fields. The server applies parsing logic, such as tokenization and pattern matching, to extract entities such as device roles, logical segments, address blocks, and link relationships. The server then constructs a graph data structure, where each node represents a communication resource and each edge represents a connection between resources, and attaches attributes such as segment membership and address assignments. The output of this step is a structured configuration model stored in memory, comprising graph nodes, graph edges, and associated attributes.

### Step 12

The server stores the structured configuration model and explanation information in the relational database. The input to this step is the graph-based configuration model and associated textual descriptions. The server serializes node and edge information into database tables, for example, a topology table and a link table, and stores textual explanations in an explanation table, each linked to the request identifier and a version identifier. The output of this step is a persistent set of records representing the AI-generated configuration and a traceable association with the original deployment state information.

### Step 13

The server generates visualization data for a configuration diagram from the structured configuration model. The input to this step is the graph-based representation of nodes and edges with attributes. The server executes a layout algorithm, such as a force-directed or layered layout, computing coordinates for each node based on connectivity and hierarchical roles (for example, core, distribution, access). The server converts the graph and coordinates into visualization primitives such as vector shapes, lines, and labels. The output of this step is visualization data, such as an SVG or equivalent object model, that can be rendered as a configuration diagram.

### Step 14

The server composes a response page that includes the configuration diagram and explanatory text. The input to this step is the visualization data and explanation information gathered from the database. The server embeds the visualization data into an HTML template and inserts the explanatory text, such as lists of segments and address ranges, into designated regions. The output of this step is an HTML document with embedded graphics and text, suitable for display on the terminal.

### Step 15

The terminal receives and renders the response page from the server. The input to this step is the HTML document and any associated resources, such as style sheets and scripts. The terminal's browser parses the HTML, constructs a document object model, and renders the configuration diagram and explanatory text on the display device. The output of this step is a visual presentation of the configuration diagram and associated information visible to the user.

### Step 16

The user reviews the displayed configuration diagram and explanatory text on the terminal. The input to this step is the rendered diagram and text. The user inspects device placements, logical segments, and address schemes and compares them with design goals, such as redundancy, segmentation, and coverage. The output of this step is a user decision to accept the configuration as-is or to issue correction instructions.

### Step 17

The terminal collects user correction instructions on the configuration diagram. The input to this step is the user's interactive actions, such as clicking, dragging, or entering text. The terminal interprets these actions as correction instructions, for example, “move this switch to another floor,” “add a new segment,” or “change the redundancy level.” The terminal structures these instructions into a correction object that references specific nodes or links by identifiers. The output of this step is a structured correction instruction set stored temporarily in the terminal's memory.

### Step 18

The terminal transmits the correction instruction set to the server. The input to this step is the structured correction instruction set. The terminal serializes the set into a structured format and sends it to the server via an HTTP POST request, including the request identifier and version identifier. The output of this step is a correction request delivered to the server's application interface.

### Step 19

The server applies the correction instructions to the stored deployment state information and configuration model. The input to this step is the correction request referencing nodes, links, and requirements. The server locates the relevant records in the device, location, requirement, topology, and link tables and updates fields accordingly, such as changing a device's floor, adding a new segment record, or flagging new redundancy constraints. The server also appends an entry to an update history table, recording the type of correction and the time of the change. The output of this step is an updated set of deployment state records, an updated configuration model, and a recorded update history entry.

### Step 20

The server analyzes the update history and adjusts future prompt sentence content. The input to this step is the update history associated with the request identifier and, optionally, with other requests of the same user or organization. The server executes aggregation queries and statistical computations to detect recurring correction patterns, such as frequent additions of guest segmentation or redundancy mechanisms. Based on the detected patterns, the server modifies template selection rules or parameter weights used in prompt construction so that subsequent prompt sentences automatically incorporate additional constraints or clarifications. The output of this step is an adjusted prompt construction configuration that will influence the next prompt sentence generated.

### Step 21

The server regenerates a prompt sentence for revision and repeats the configuration generation cycle. The input to this step is the updated deployment state information, the adjusted prompt construction configuration, and any new requirements specified in the corrections. The server constructs a new prompt sentence that references the previous design context and explicitly instructs the generative AI model to revise the configuration in accordance with the corrections, such as “maintain current devices but add an isolated guest segment” or “introduce a redundant link between specific nodes.” The server then submits this prompt sentence to the generative AI model, receives a new response, and repeats the parsing, storage, visualization, and presentation sequence. The output of this step is a revised configuration diagram and explanation that more closely matches the user's requirements while leveraging the system's learned adjustments from prior corrections.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional tools for designing communication networks require human experts to manually interpret heterogeneous deployment data, to decide architectural patterns, and to translate such decisions into configuration diagrams and explanatory documentation. These tools typically operate as static drawing applications or rule-based configurators that do not effectively utilize large volumes of stored deployment history and traffic information. As a result, the quality and consistency of generated network configuration diagrams strongly depend on the skills of individual engineers.

Furthermore, when such tools are exposed to non-expert users through user interfaces on terminal devices, the system usually treats every user identically, without accounting for the user's emotional state or comprehension level. Existing systems do not dynamically adapt either (i) the instructions given to an artificial intelligence engine or (ii) the resulting explanatory content to match the cognitive load, stress level, or familiarity of each user. Consequently, non-expert users often receive diagrams and explanations that are either too complex or too simplified, which degrades usability, slows down configuration cycles, and increases the risk of misconfiguration.

In addition, many current approaches that employ machine learning or generative models merely accept a direct textual query from a user and return a textual answer. Such approaches do not implement a structured, processor-controlled pipeline that: (1) aggregates deployment status and usage history in a storage device, (2) programmatically constructs rich prompt sentences for a generative AI model, (3) converts the model output into machine-processable diagram description data, and (4) closes the loop by re-prompting and adapting the explanation based on machine-estimated user emotion. This lack of integrated, automated processing limits the extent to which computer resources can be used to offload expert reasoning and to improve the overall efficiency and reliability of network design operations.

Therefore, there is a need for an improved computer-implemented system that: (i) transforms stored network deployment information and user inputs into optimized prompt sentences for a generative AI model, (ii) programmatically converts AI outputs into diagram description data suitable for automatic rendering, and (iii) automatically estimates and uses the user's emotional state to adapt prompts and explanatory content. Such a system should improve the functioning of the computer itself by orchestrating storage, prompt generation, model invocation, diagram synthesis, and emotion-aware content adaptation in a unified processing flow, thereby enabling more efficient, accurate, and user-appropriate generation of network configuration diagrams and related explanations.

The specific processing by the specific processing unit 290 of the data processing device 12 in Application Example 2 is realized by the following means.

The present invention provides a server comprising a processor and a storage device, the processor being configured to store, in the storage device, network deployment information collected by a communication control device, to generate, based on the network deployment information stored in the storage device and input information received from a terminal device operated by a user, a prompt sentence for input to a generative AI model, the prompt sentence including requirements necessary for generation of a network configuration diagram and requirements relating to explanatory content of the network configuration diagram, to input the prompt sentence to the generative AI model and convert an output result relating to a network configuration, obtained from the generative AI model, into shape description data or graph description data for generation of the network configuration diagram, to generate, based on the shape description data or the graph description data, image data of the network configuration diagram by using drawing software, to estimate an emotional state of the user by using an emotion estimation model based on facial expression information and audio information of the user acquired from an imaging device and an audio acquisition device provided in the terminal device, to adjust, in accordance with the estimated emotional state of the user, at least one of the prompt sentence and an explanatory text obtained from the generative AI model so as to simplify or detail the explanatory text and generate explanatory information corresponding to a comprehension level of the user, and to transmit the generated network configuration diagram and the explanatory information to the terminal device via a communication path and provide the network configuration diagram and the explanatory information in a displayable format on the terminal device. This enables the computer system itself to more efficiently process stored deployment data and user inputs into optimized prompt sentences for the generative AI model, to automatically synthesize and render network configuration diagrams from model outputs, and to adapt both the prompting and the explanatory content in real time based on an automatically estimated emotional state of the user, thereby improving the technical performance, usability, and reliability of network design and management operations executed by the server.

The term “processor” refers to a hardware computation unit, or a set of hardware computation units, that executes machine-readable instructions, and may include one or more central processing units, graphics processing units, digital signal processors, or other programmable logic devices.

The term “storage device” refers to a hardware component configured to store data in a non-transitory manner, and may include a magnetic storage medium, an optical storage medium, a semiconductor memory, or any combination thereof.

The term “communication control device” refers to an electronic apparatus that manages transmission and reception of data over a communication network, and may include a network controller, a gateway, a router, a switch, or a similar communication apparatus.

The term “network deployment information” refers to information indicating a state of installation, interconnection, and operation of communication devices in a network, including types of devices, logical and physical connections, addressing schemes, and traffic characteristics.

The term “terminal device” refers to an information processing apparatus operated by a user to interact with the server, and may include a portable communication device, a tablet device, a personal computer, an industrial controller, or a similar user-facing device.

The term “input information” refers to data provided by a user through the terminal device, including at least device types, identification information, connection conditions, installation environments, design objectives, and user queries.

The term “generative AI model” refers to a trained artificial intelligence model that generates output data, such as text, code, or structured descriptions, in response to input data, by using statistical or machine-learning techniques such as neural networks.

The term “prompt sentence” refers to a machine-generated or human-generated instruction text that is supplied as input to the generative AI model to specify requirements for a task, including at least requirements for generating a network configuration diagram and associated explanatory content.

The term “network configuration diagram” refers to a visual representation of communication devices and connections in a network, including nodes representing devices and edges representing communication links, used for design, deployment, and management of the network.

The term “shape description data” refers to data describing graphical elements for drawing a network configuration diagram, including node shapes, positions, labels, and link representations, in a format interpretable by drawing software.

The term “graph description data” refers to data representing a network topology as a mathematical graph including nodes and edges, expressed in a structured text format suitable for conversion into a visual diagram.

The term “drawing software” refers to a software program that converts shape description data or graph description data into image data, and may include a diagram rendering engine, a graph layout engine, or a similar visualization tool.

The term “image data” refers to digital data representing a visual image of the network configuration diagram, encoded in a raster or vector format suitable for display on a screen or projection device.

The term “imaging device” refers to a hardware component that captures visual information of a subject, such as a camera or an image sensor, and outputs digital image data representing at least a user's face or surroundings.

The term “audio acquisition device” refers to a hardware component that captures sound, such as a microphone or an array of microphones, and outputs digital audio data including at least the user's voice.

The term “facial expression information” refers to data derived from image data of a user's face, including at least facial feature positions, movements, or patterns used to infer an emotional state.

The term “audio information” refers to data derived from sound signals captured by the audio acquisition device, including at least voice characteristics, prosodic features, and spectral features used to infer an emotional state.

The term “emotion estimation model” refers to a machine-learning model or rule-based model configured to estimate an emotional state of a user based on at least facial expression information, audio information, textual information, or any combination thereof.

The term “emotional state” refers to a state of a user's affect or mood inferred by the emotion estimation model, including, for example, stress, confusion, neutrality, satisfaction, or joy.

The term “explanatory text” refers to textual output generated by the generative AI model that describes a network configuration, design rationale, or operational characteristics of a network configuration diagram.

The term “explanatory information” refers to information presented to the user to explain the network configuration diagram, including at least the explanatory text and optionally supplemental structured data, annotations, or step-by-step guidance.

The term “comprehension level” refers to an inferred degree of a user's understanding or technical proficiency, which is estimated based on at least the emotional state, user interaction history, or provided profile information.

The term “communication path” refers to a logical or physical connection over which data is transmitted between the server and the terminal device, and may include wired links, wireless links, or combinations thereof, using one or more communication protocols.

The term “structured data” refers to data organized according to a predefined format or schema, such as a key-value structure, a table, or a hierarchical representation, which is suitable for machine processing and storage.

The term “usage history” refers to information representing past interactions with the system or past use of network resources, including at least prior user inputs, prior configurations, and applied network changes.

The term “traffic information” refers to data indicating communication patterns in a network, including at least bandwidth usage, latency, packet loss, and flow characteristics between devices.

The term “network address design” refers to a logical arrangement of addressing in a network, including allocation of address ranges, subnet structures, and segmentation policies.

The term “route control” refers to control of paths taken by data packets in a network, including at least routing protocols, routing policies, and selection of primary and backup routes.

In one embodiment, a server, a terminal, and a user cooperate to implement the claimed system for generating and presenting network configuration diagrams and emotion-adaptive explanatory information by using a generative AI model and structured prompt sentences.

The server includes at least one processor, a main memory, a non-transitory storage device, and a network interface. The storage device stores system programs, a network deployment database, a model parameter store, and log data. The processor executes these programs to perform data acquisition, prompt sentence generation, generative AI model invocation, diagram synthesis, emotion estimation, and adaptive content generation.

The terminal includes a processor, a memory, a display device, an imaging device such as a camera, an audio acquisition device such as a microphone, and a communication interface. The terminal executes a web browser or a dedicated application, renders user interfaces received from the server, collects user inputs and sensor data, and transmits such data to the server. The user operates the terminal to provide network-related input information and to view the generated network configuration diagram and explanatory information.

### A. Hardware and Software Configuration of the Server

The server executes an operating system such as a general-purpose server operating system and a web application framework such as a server-side framework to provide network APIs. The server uses a relational database management system as the storage device for network deployment information and user interaction histories. The server may further employ a graph drawing engine, such as a graph layout library, to convert graph description data into image data representing a network configuration diagram.

The server executes a generative AI model on dedicated computing resources. In one embodiment, the server invokes a remote neural-network-based generative language model via an application programming interface. In another embodiment, the server runs a locally hosted neural network on a graphics processing unit or tensor processing unit. The generative AI model may employ a transformer architecture having multiple self-attention layers, feed-forward layers, and layer normalization. The model parameters are stored in the storage device and loaded into memory for inference.

The server also maintains an emotion estimation model. In one embodiment, the emotion estimation model includes: (i) a convolutional neural network followed by fully connected layers for facial expression recognition, and (ii) a recurrent or transformer-based network for speech emotion recognition operating on acoustic feature vectors, such as Mel-frequency cepstral coefficients, pitch contours, and energy features. The server stores the learned weights of these models in the storage device and loads them into memory when estimating a user's emotional state.

### B. Data Structures and Internal Representations

The server stores network deployment information in the database using structured tables. The server uses, for example, a table “devices” having columns such as device_id, device_type, vendor_class, logical_role, address_range, physical_location, interface_count, and capability_flags. The server uses another table “links” having columns such as link_id, source_device_id, source_port, target_device_id, target_port, link_type, and bandwidth. The server uses a table “projects” or “scenarios” that associates a user, a factory area, or an office site with a set of devices and links.

The server internally represents a candidate network configuration as a graph data structure. The graph includes nodes representing devices and edges representing logical or physical connections. Each node structure contains pointers to records in the devices table and stores attributes such as layer_role, redundancy_group_id, and zone_id. Each edge structure contains link attributes such as latency_class, redundancy_priority, and security_level.

The server stores prompt sentences and generative AI model responses in a table “ai_sessions.” The server relates each prompt sentence to a specific project and stores metadata such as timestamp, emotion_state, and explanation_complexity_level. The server further stores emotion estimation results in a table “user_emotions,” including fields such as valence_score, arousal_score, and discrete_emotion_label.

### C. Generative AI Model Configuration and Learning

The server trains the generative AI model in advance using supervised learning on a corpus of network design examples. Each training sample includes an input sequence and an output sequence. The input sequence encodes structured information about devices, links, and deployment objectives. The output sequence provides a natural-language description and an associated graph description (for example, in a domain-specific graph notation).

The server defines a vocabulary that includes tokens for generic language, network device types, roles, and graph syntax constructs. The model architecture comprises a stack of transformer encoder-decoder blocks. Each block includes multi-head self-attention, cross-attention, and position-wise feed-forward layers with activation functions such as rectified linear units or Gaussian error linear units. The model uses positional encodings to represent token order.

The server trains the generative AI model by minimizing a cross-entropy loss between predicted tokens and ground-truth tokens. The server uses an optimizer such as Adam with learning-rate scheduling. The server may perform data augmentation by randomly permuting devices within the same layer, adding synthetic examples with varied but equivalent topologies, and adding paraphrased explanations. The server stores the resulting model parameters in the storage device.

During inference, the server performs beam search or top-k sampling to decode the output sequence, balancing determinism and diversity. Because the model is trained specifically on structured network design tasks and graph syntax, the server can rely on higher syntactic correctness and semantic coherence in the generated network configurations, which improves computational efficiency by reducing the need for repeated correction cycles.

### D. Emotion Estimation Model Configuration and Learning

The server configures the facial expression recognition model as a convolutional neural network having multiple convolutional and pooling layers, followed by fully connected layers outputting a probability distribution over discrete emotion classes such as neutral, stress, confusion, satisfaction, and joy. The server trains this model on labeled facial expression datasets using a cross-entropy loss and gradient-based optimization.

The server configures the speech emotion recognition model as a recurrent neural network or transformer-based network that processes sequences of acoustic feature vectors. The server extracts short-time frames from audio data, calculates Mel-frequency cepstral coefficients, pitch contours, and short-time energy, and feeds these feature sequences into the model. The server trains the model on labeled audio datasets and minimizes a loss function similar to that used for the facial expression model.

The server fuses outputs from the facial expression model, the speech model, and a sentiment analysis model that processes user-typed or transcribed text. The server may compute a weighted sum of logits or apply a small fully connected network to combine features from these sub-models. By calibrating the fusion model on multi-modal emotion data, the server improves robustness and reduces misclassification rates.

### E. Prompt Sentence Generation and Adaptation

The server generates a prompt sentence using deterministic and rule-based procedures operating on the structured data and emotion state, rather than simply passing the raw user text to the generative AI model. The server uses a template-based generator that composes sentences from fields in the database and from stored phrase libraries.

For example, the server composes a prompt sentence such as:

“You are a network architect for an industrial factory. The current project includes one core router RT-200, one access switch SW-100, and a new robot arm RA-2023 on Production Line 1. The objective is to maximize reliability and keep cabling changes minimal. Based on this information and the existing deployment status, generate an optimal network configuration and describe the topology. Output the topology in Graphviz DOT format and provide a short explanation for a non-expert user.”

The server selects different templates and phrase complexities according to the estimated emotion state and inferred comprehension level. When the emotion estimation model indicates that the user is stressed or confused, the server uses templates that instruct the generative AI model to produce shorter sentences, avoid jargon, and limit the number of visible technical parameters. When the user appears confident or joyful, the server uses templates that request more detailed technical content, including network address design and route control explanations.

The server also uses stored past deployment information, usage history, and traffic information when composing the prompt sentence. The server includes specific constraints, such as “keep existing core routers unchanged,” or “minimize additional links in high-congestion segments,” enabling the generative AI model to produce configurations that are optimized for the actual environment rather than generic examples. This structured prompt generation improves computational efficiency because the generative AI model receives precise context, reducing the search space and leading to fewer correction iterations.

### F. Conversion of Generative AI Output into Diagram Data

The server receives textual output from the generative AI model, which typically includes a description and a graph specification. The output may contain a block of graph description, for example in a simplified graph syntax where devices are described as nodes and links as edges. The server parses the graph description using a dedicated parser that validates syntax and semantics.

The server maps the nodes and edges described by the AI output back to the device and link records stored in the database. The server resolves device identifiers, checks consistency with interface counts, and ensures that no link exceeds device port capacities. When inconsistencies are detected, the server applies deterministic correction rules such as rerouting edges to unused ports or splitting overloaded nodes into multiple access layers. These corrections implement non-conventional, machine-specific heuristics that are not simply duplications of human mental steps, such as automatically adjusting layering and connection density based on precomputed load metrics.

The server then converts the validated graph into graph description data suitable for the drawing software. The server specifies attributes for each node, such as shape type, color corresponding to device role, label text, and position hints. The server also sets edge attributes such as line style, bandwidth annotations, and redundancy group identifiers. This structured graph description enables the drawing engine to compute an optimized layout that minimizes edge crossings and highlights critical paths.

### G. Emotion-Aware Adaptation of Explanatory Information

The server receives an explanatory text from the generative AI model along with or separate from the graph specification. The server then generates emotion-adapted explanatory information. When the emotion estimation model indicates high stress or low comprehension, the server segments the explanatory text into smaller paragraphs, removes subordinate clauses, and replaces domain-specific terms with more generic descriptions using an additional call to the generative AI model with a simplification prompt sentence. For example, the server may use a prompt sentence such as:

“Rewrite the following network design explanation so that a beginner user who is feeling stressed can understand it. Use clear, short sentences and avoid complex jargon.”

When the estimated emotion state indicates confidence, the server issues a different prompt sentence such as:

“Rewrite the following network design explanation for an experienced network engineer. Include details such as VLAN assignments, IP subnets, routing protocols, and redundancy strategies.”

By dynamically altering the prompt sentences based on emotion, the server causes the generative AI model to produce multiple explanation variants with different complexity levels. This selective prompting reduces the number of interactions needed to reach adequate understanding and improves the effectiveness of the computer-based system in accommodating diverse users.

### H. Technical Effects and Improvement of Computer Technology

The server improves computer technology in several ways beyond simple automation of human work. First, the server employs specific data structures (relational tables, graph representations, structured prompt records) and deterministic algorithms (template-based prompt construction, graph validation and correction heuristics) to tightly integrate storage, prompt generation, generative AI inference, diagram rendering, and emotion estimation. This integration reduces redundant model calls, prevents inconsistent states, and lowers communication load between components.

Second, by structuring the input to the generative AI model via optimized prompt sentences, the server reduces the required model context length and avoids extraneous information, which decreases computation time, memory consumption, and latency in generating a valid configuration. The server thus improves processing speed and resource efficiency on the computing hardware.

Third, the emotion estimation model and its use in controlling both the prompt sentences and the explanatory information provide an adaptive feedback loop that conventional static systems lack. The server, rather than a human, automatically modulates explanation complexity and diagram detail. This modulation, which is based on quantitative emotion and comprehension estimates stored and updated in the database, reduces the number of user-initiated retries and follow-up queries, which in turn reduces network traffic and server load.

Fourth, the server applies non-human, rule-based configuration validation and adjustment procedures derived from machine-computed metrics such as port utilization, path diversity scores, and historical failure rates. These procedures allow the server to preemptively correct or optimize AI-generated proposals before presenting them to the user. This reduces configuration errors and improves the overall reliability of network design output, thereby enhancing the technical functioning of the network deployment process.

### I. Example Usage Scenario

The user operates a terminal in an industrial environment such as a factory. The user inputs information such as “router model: RT-200, access switch model: SW-100, robot arm model: RA-2023, production line: Line 1, objective: maximize reliability and minimize cabling changes.” The terminal sends structured data to the server. The server stores this information in the database and generates the following prompt sentence:

“You are a network architect for an industrial factory. The current project includes one core router RT-200, one access switch SW-100, and a new robot arm RA-2023 on Production Line 1. The objective is to maximize reliability and keep cabling changes minimal. Based on this information and the existing deployment status, generate an optimal network configuration and describe the topology. Output the topology in Graphviz DOT format and provide a short explanation for a non-expert user.”

The server inputs this prompt sentence to the generative AI model and receives an output describing a topology and a corresponding graph specification. The server validates and corrects the graph according to the stored constraints, generates image data of a network configuration diagram, and stores the diagram and explanation. Simultaneously, the terminal captures the user's facial expressions and voice, and the server estimates the user's emotional state as stressed. The server then uses an additional prompt sentence for explanation simplification and obtains a more accessible description.

The terminal displays the resulting network configuration diagram and stress-adapted explanation on the display device or a projection device. The user can understand the configuration without deep technical knowledge, and the server has achieved this by using specific internal models, data structures, and rule-based processing that improve the computer system's ability to generate consistent, optimized, and user-tailored network designs.

### J. Variations and Alternative Embodiments

The server may be implemented as a distributed system including multiple physical machines, where one machine specializes in database storage, another in generative AI inference, and another in emotion estimation. The terminal may be a handheld device, a desktop workstation, or an embedded panel attached to an industrial machine. The generative AI model may be replaced by another neural network architecture, such as a sequence-to-graph model, as long as the server continues to construct structured prompt sentences and convert the model output into graph description data.

The emotion estimation model may use additional modalities such as heart-rate sensors or interaction timing metrics, and may adapt the weights assigned to each modality according to context. The server may further incorporate reinforcement learning to adjust prompt templates based on observed downstream performance metrics such as user error rate and time to completion.

In all such variations, the server, the terminal, and the user interact according to the principles described above: the server stores and processes network deployment information, constructs and adapts prompt sentences for a generative AI model, converts model outputs into diagram data, estimates and utilizes the user's emotional state, and thereby improves the technical performance, efficiency, and reliability of computer-implemented network configuration design and explanation.

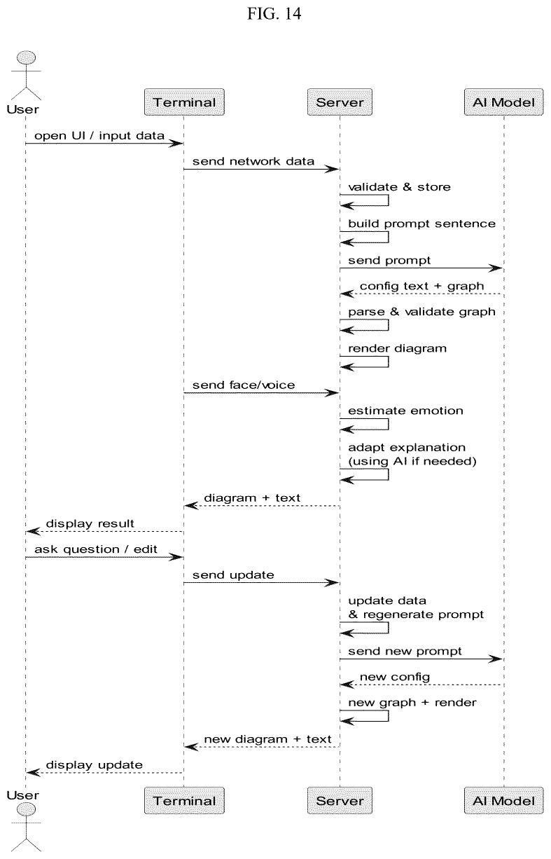

The following describes the processing flow using FIG. 14.

### Step 1

The user operates the terminal to open an application or web browser and access a user interface provided by the server.

The input is a request URL or application launch command from the user, and the output is a rendered initial screen on the terminal.

The terminal sends an HTTP request to the server, receives HTML, style, and script data, and renders a form that allows the user to enter network device information, deployment objectives, and environment settings.

### Step 2

The user operates the terminal to input network-related information into the displayed form.

The input is the user's key and touch operations, and the output is a set of populated form fields inside the terminal memory.

The terminal collects values such as device types, identification information, connection constraints, installation areas, and design objectives, and updates its internal data model to reflect the user's entries.

### Step 3

The terminal converts the form data into structured data and transmits it to the server.

The input is the set of populated form fields, and the output is a structured payload, for example a key-value structure, sent over a network connection.

The terminal serializes the input fields into a structured representation, attaches metadata such as user identifier and project identifier, and sends the resulting data to the server via a communication protocol such as HTTP over a secure channel.

### Step 4

The server receives the structured data from the terminal and validates the content.

The input is the structured payload from the terminal, and the output is a normalized and validated data record.

The server parses the payload, checks for required fields, verifies that numeric values fall within allowable ranges, resolves identifiers against existing records, and constructs normalized internal objects representing devices, links, and objectives.

### Step 5

The server stores the validated network deployment information in a storage device.

The input is the normalized internal objects generated in Step 4, and the output is one or more database records written to a network deployment database.

The server maps each object to one or more tables, such as device tables and link tables, executes insert or update commands, and commits the transaction so that the network deployment information becomes persistent and can be used in later processing.

### Step 6

The server aggregates stored deployment data and history required for generating a new configuration.

The input is a project identifier or scenario identifier derived from the request, and the output is an aggregated in-memory representation of the current deployment state.

The server issues database queries to collect all devices, connections, historical usage, and traffic statistics for the relevant project, combines them into graph-like structures, and annotates these structures with additional attributes such as redundancy status and performance indicators.

### Step 7

The server generates a prompt sentence for a generative AI model based on the aggregated deployment data and the user's objectives.

The input is the aggregated in-memory deployment representation and the design objectives, and the output is one or more prompt sentences expressed in natural language.

The server selects template phrases, fills device and link details into parameter slots, appends constraints and goals, and constructs a coherent instruction text that describes what type of network configuration is required and how the topology and explanation should be formatted.

### Step 8

The server optionally adjusts the prompt sentence according to previously stored user emotion and comprehension data.

The input is the initial prompt sentence and any stored emotion and comprehension indicators for the user or project, and the output is an adjusted prompt sentence tuned for the user's condition.

The server examines emotion records, such as stress level or confidence level, and modifies the wording of the prompt to request simpler or more detailed explanations, fewer or more technical terms, and a different level of diagram detail for the generative AI model.

### Step 9

The server invokes the generative AI model with the prepared prompt sentence to obtain a candidate network configuration.

The input is the final prompt sentence and any necessary system instructions, and the output is a textual response including a configuration description and graph-like specification.

The server packages the prompt into a request payload, transmits it to the generative AI model interface, waits for the model to generate tokens according to its internal neural network computation, and receives the complete output sequence representing the proposed configuration.

### Step 10

The server parses the textual response from the generative AI model and extracts graph description data and explanatory text.

The input is the raw textual output from Step 9, and the output is a structured graph description and a separated natural-language explanation.

The server scans the output, detects marker sections that contain graph syntax, parses those sections into node and edge structures, separates the remaining narrative text as explanatory content, and validates that required components such as core nodes and access nodes are present.

### Step 11

The server validates and adjusts the extracted graph description data against the deployment database.

The input is the parsed graph description and the stored deployment information from Step 5 and Step 6, and the output is a corrected and consistent graph representation.

The server checks that each node in the graph corresponds to an actual or planned device record, verifies that link counts do not exceed interface capacities, checks for invalid loops or unreachable segments, and, when inconsistencies are identified, automatically rewires edges or reassigns ports according to predefined optimization and correction rules.

### Step 12

The server generates layout and style information for diagram rendering from the corrected graph representation.

The input is the consistent graph structure from Step 11, and the output is graph description data suitable for a drawing engine.

The server assigns node shapes based on device roles, maps roles to colors and line styles, computes layout hints such as vertical layering or left-to-right ordering, and encodes these properties into a structured graph notation that the drawing engine can interpret.

### Step 13

The server renders image data of the network configuration diagram using a drawing engine.

The input is the graph description data produced in Step 12, and the output is image data such as a vector image or raster image file.

The server calls the drawing engine with the graph description, the engine performs layout optimization and rendering computations, and the server receives a generated image representing the network configuration suitable for display on various terminal devices.

### Step 14

The terminal captures the user's facial images and audio signals, with the user's consent, while the user interacts with the interface.

The input is the user's physical presence and speech, and the output is digital image frames and audio samples stored in the terminal memory.

The terminal drives the imaging device and the audio acquisition device at predefined sampling rates, buffers the captured frames and audio segments, optionally compresses them, and prepares them for transmission to the server.

### Step 15

The terminal transmits emotion-related sensor data to the server for emotion estimation.

The input is the buffered image frames and audio samples from Step 14, and the output is one or more data packets carrying sensor data over the network.

The terminal segments the captured media into time windows, encapsulates the segments along with timestamps and user identifiers into structured payloads, and sends them to the server through a secure communication channel.

### Step 16

The server estimates the user's emotional state based on the sensor data.

The input is the sensor payload from the terminal and any existing emotion history for the user, and the output is an estimated emotional state label or score.

The server decodes or preprocesses the media, extracts facial features and audio features, feeds those feature vectors into the emotion estimation models, calculates probabilities for various emotion classes, optionally smooths the results over time, and stores a resulting emotional state indicator in the database.

### Step 17

The server adapts the explanatory text according to the estimated emotional state and the inferred comprehension level.

The input is the initial explanatory text from Step 10 and the emotional state from Step 16, and the output is an adjusted explanatory text suited to the user's condition.

The server decides whether to simplify or enrich the explanation, optionally composes a new prompt sentence that instructs a generative AI model to rewrite the text in simpler or more technical language, obtains a rewritten explanation, and selects the version whose complexity matches the user's estimated comprehension level.

### Step 18

The server assembles a response containing the network configuration diagram and the adapted explanatory information and transmits it to the terminal.

The input is the image data from Step 13 and the adapted explanatory text from Step 17, and the output is a response payload formatted for presentation.

The server packages the image and text into a response structure, adds references such as diagram identifiers and timestamps, and sends the response back to the terminal via the network interface.

### Step 19

The terminal receives the response and displays the network configuration diagram and explanatory information to the user.

The input is the response payload from Step 18, and the output is a visual presentation on the terminal display.

The terminal decodes the image, renders it within a graphical component, lays out the accompanying text near the diagram, and presents interactive elements allowing the user to zoom, pan, or select components of the network configuration diagram.

### Step 20

The user reviews the displayed diagram and explanation and may submit follow-up questions or modification requests through the terminal.

The input is the diagram and explanation shown on the display, and the output is new user interaction data such as questions or edits.

The user examines the configuration, decides whether certain devices or connections should be changed, types questions or edits into the interface, and instructs the terminal to send these updates to the server, thereby initiating another cycle of data processing and prompt sentence generation by the server.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

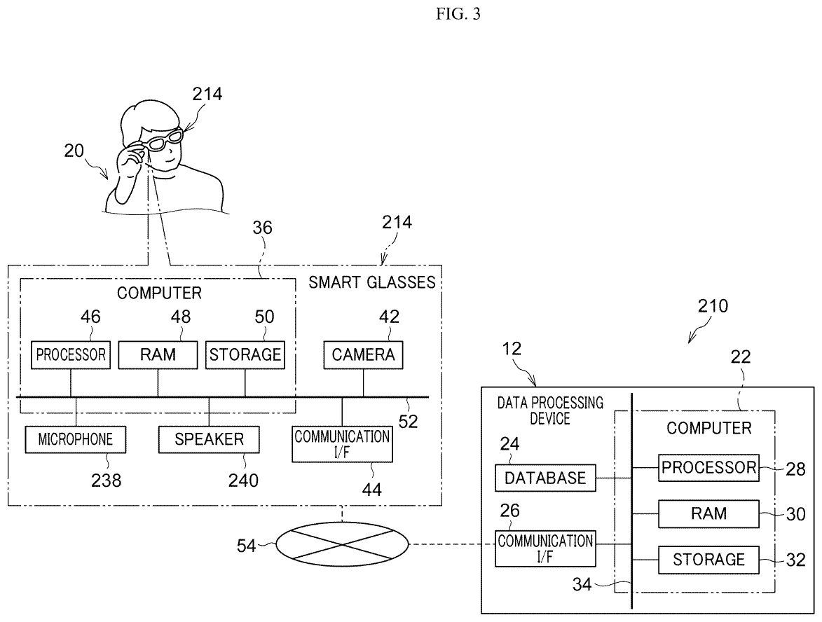

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

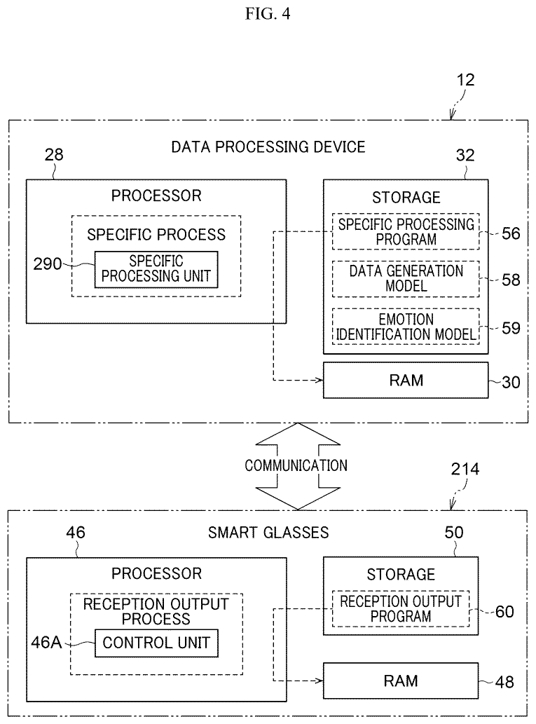

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

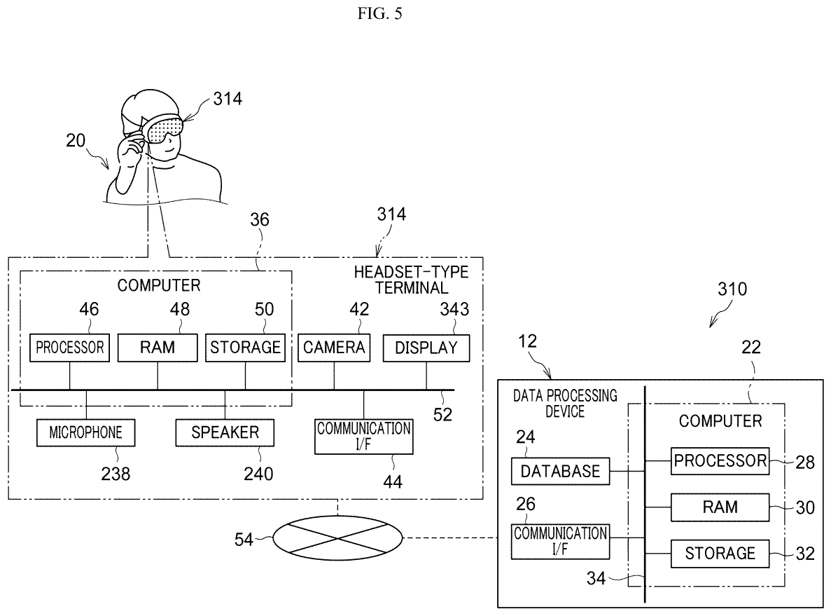

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

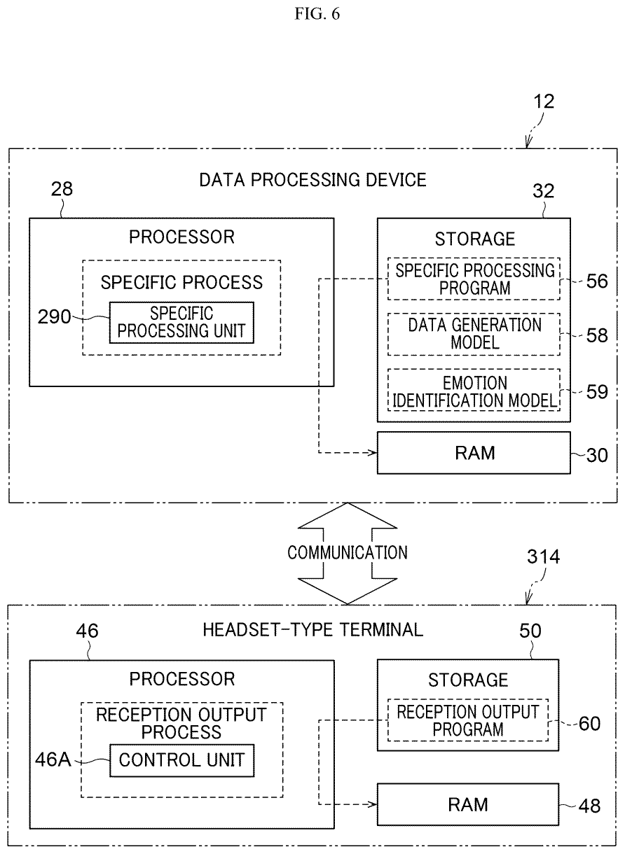

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

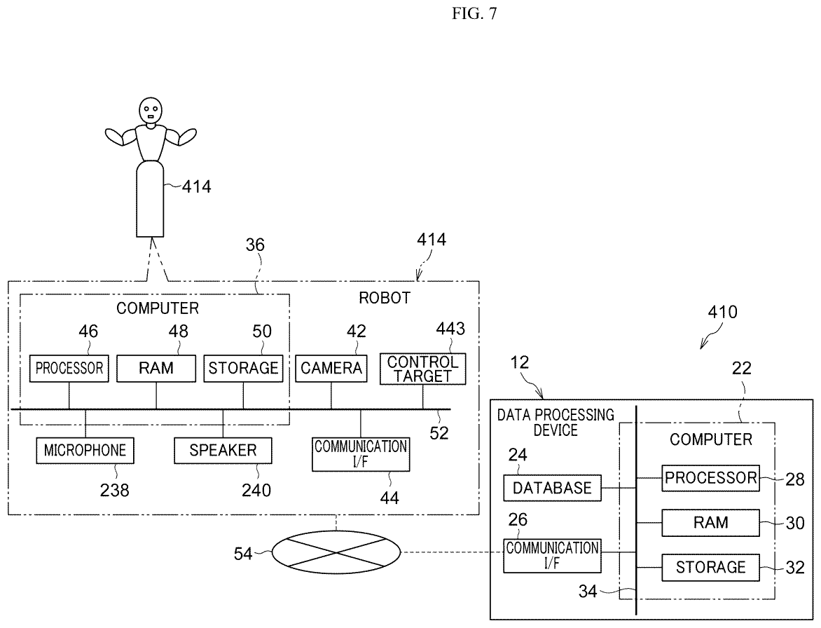

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

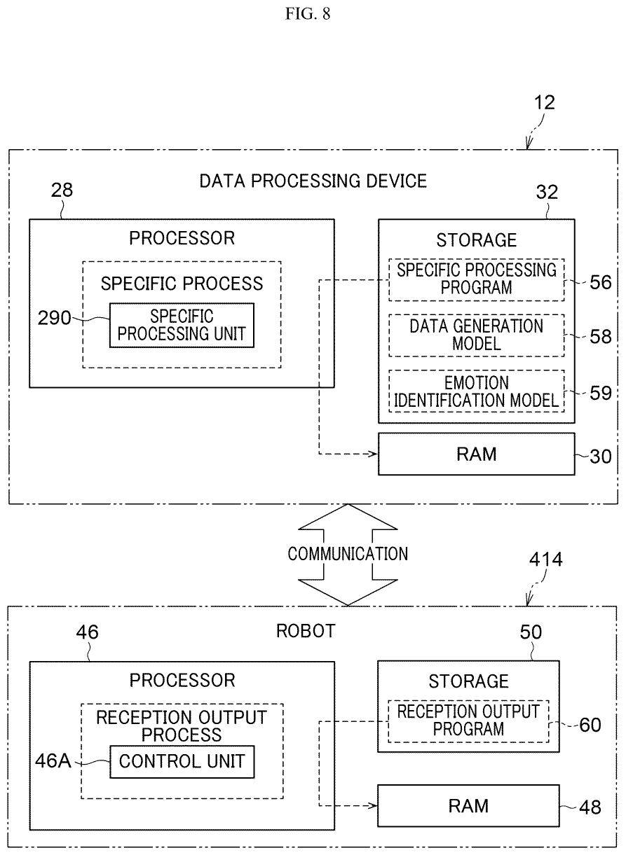

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

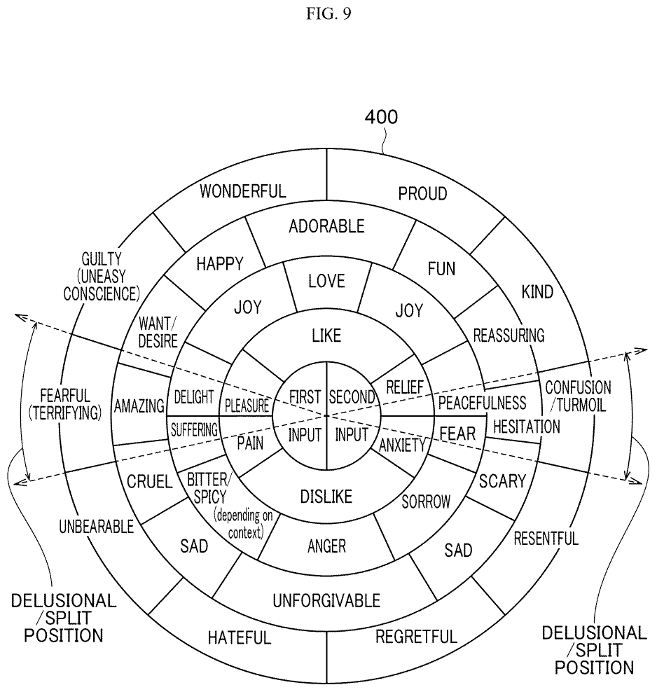

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

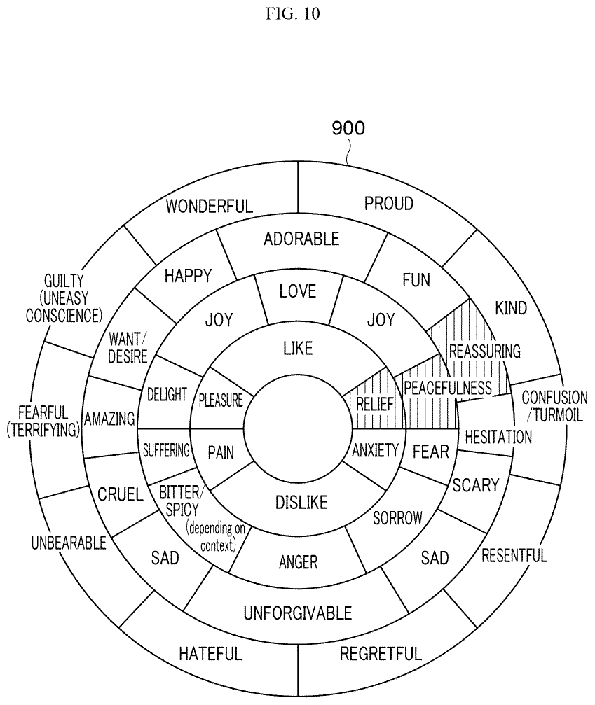

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive, via a communication path, deployment information relating to communication equipment from a user terminal, and store the deployment information as structured data in an information management area of a storage device,
acquire the structured data stored in the information management area, and generate, based on the structured data, a prompt sentence in a natural language to be used as an input instruction to a generative artificial intelligence model,
input, via an external interface, the prompt sentence to the generative artificial intelligence model, and acquire explanation information regarding a network connection structure output from the generative artificial intelligence model,
analyze the explanation information to generate an internal representation indicating a logical configuration including communication equipment and communication paths, and create configuration diagram data that visually represents the communication equipment and the communication paths based on the internal representation, and
output the configuration diagram data as image data or drawing description data, and provide the configuration diagram data and the explanation information to the user terminal as presentation information.

### Supplementary 2

The system according to supplementary 1,
wherein the processor is configured to extract information corresponding to a scale of a usage site, a number of users, reliability requirements, and security requirements included in the structured data, and add the extracted information as consideration conditions to the prompt sentence.

### Supplementary 3

The system according to supplementary 1,
wherein the processor is configured to extract, from the explanation information, descriptions relating to types of communication devices, interconnection relationships, and logical segmentation, and, based on an extraction result, when a configuration inconsistency is detected, modify contents of the prompt sentence and perform re-input of the prompt sentence to the generative artificial intelligence model so as to adjust the configuration diagram data.

### Application Example 1

### Supplementary 1

A system comprising a processor,
wherein the processor is configured to
store, in a storage device, deployment status information of a communication network and state information regarding connection target equipment,
generate, based on the deployment status information and the state information, structured data including topology information, communication quality information, and connection requirement conditions, and create a prompt sentence including the structured data,
input the prompt sentence and the structured data to a generative AI model, and cause the generative AI model to generate network configuration diagram data including elements of the communication network and connection relationships between pieces of equipment,
generate, based on the network configuration diagram data and the communication quality information, graph data representing a plurality of candidate communication paths between pieces of equipment, and calculate an optimal communication path and an alternative communication path,
output the network configuration diagram data and a calculation result regarding the communication paths as visualization data, and cause a display device to display a network configuration diagram including the pieces of equipment and the communication paths, and
acquire, via the display device, a natural language inquiry input by a user, generate a prompt sentence including the inquiry, and input the prompt sentence to the generative AI model to cause the generative AI model to generate explanation information or modification proposals regarding the network configuration diagram and the communication paths.

### Supplementary 2

The system according to supplementary 1,
wherein the processor is configured to
generate, based on the network configuration diagram data and the calculation result regarding the communication paths, setting information including address assignment information, route control information, and quality control information, and output instruction information for using the setting information to configure a network device or the connection target equipment.

### Supplementary 3

The system according to supplementary 1,
wherein the processor is configured to
acquire, in a time series, the deployment status information of the communication network, the communication quality information, and the state information regarding the connection target equipment, dynamically adjust contents of the prompt sentence and the structured data based on the time-series information, and update the network configuration diagram and the communication paths.

### Example 2

### Supplementary 1

A system comprising a processor,
wherein the processor is configured to
receive deployment state information of communication resources from an external input/output device and store the deployment state information as structured information in a storage device,
aggregate, based on the deployment state information stored in the storage device, types, quantities, installation locations, and requirement specifications of the communication resources, and construct, in a natural language, a prompt sentence to be used as input to a generative AI model,
transmit the prompt sentence to the generative AI model via a communication unit and generate configuration information representing connection relationships among the communication resources based on output information acquired from the generative AI model,
convert the configuration information into visualization data and generate output information that is presentable as a configuration diagram of a communication system on a display device, and
reflect, in the deployment state information or in the prompt sentence, correction instructions for the configuration diagram received from a user via the display device, and update the prompt sentence for re-input to the generative AI model.

### Supplementary 2

The system according to supplementary 1,
wherein the processor is configured to include, in the prompt sentence, conditions related to assignment of communication identifiers, route selection, and segmentation, and thereby acquire, from the generative AI model, explanation information regarding a logical connection configuration and an address scheme.

### Supplementary 3

The system according to supplementary 1,
wherein the processor is configured to analyze an update history of the deployment state information stored in the storage device or a history of correction instructions from the user, and dynamically adjust content or requirement conditions of the prompt sentence based on a result of the analysis.

### Application Example 2

### Supplementary 1

A system comprising a processor,
wherein the processor is configured to
store, in a storage device, network deployment information collected by a communication control device,
generate, based on the network deployment information stored in the storage device and input information received from a terminal device operated by a user, a prompt sentence for input to a generative AI model, the prompt sentence including requirements necessary for generation of a network configuration diagram and requirements relating to explanatory content of the network configuration diagram,
input the prompt sentence to the generative AI model and convert an output result relating to a network configuration, obtained from the generative AI model, into shape description data or graph description data for generation of the network configuration diagram,
generate, based on the shape description data or the graph description data, image data of the network configuration diagram by using drawing software,
estimate an emotional state of the user by using an emotion estimation model based on facial expression information and audio information of the user acquired from an imaging device and an audio acquisition device provided in the terminal device,
adjust, in accordance with the estimated emotional state of the user, at least one of the prompt sentence and an explanatory text obtained from the generative AI model so as to simplify or detail the explanatory text, and generate explanatory information corresponding to a comprehension level of the user, and
transmit the generated network configuration diagram and the explanatory information to the terminal device via a communication path and provide the network configuration diagram and the explanatory information in a displayable format on the terminal device.

### Supplementary 2

The system according to supplementary 1,
wherein the processor is configured to
control the terminal device to accept, from the user, input operations relating to types of network devices, identification information, connection conditions, and installation environments, convert the input information into structured data, transmit the structured data to the communication control device, and cause the terminal device to display, on a display device or a projection device, the network configuration diagram and the explanatory information received from the communication control device.

### Supplementary 3

The system according to supplementary 1,
wherein the processor is configured to
acquire past network deployment information, usage history, and traffic information stored in the storage device, and dynamically adjust the prompt sentence to be input to the generative AI model based on the acquired information so as to optimize generation of the network configuration diagram and explanatory information relating to at least one of network address design and route control.

What is claimed is:

1. A system comprising:
circuitry configured to:
receive, via a communication interface coupled to a packet-switched network, deployment information relating to communication equipment from a terminal device, and store the deployment information as structured data in an information management area of a storage device;
acquire the structured data stored in the information management area and generate, based on the structured data, a prompt sentence in a natural language to be used as an input instruction to a generative neural network model operating on a deep learning framework;
input the prompt sentence to the generative neural network model via an external interface and acquire explanation information regarding a network connection structure output from the generative neural network model;
analyze the explanation information to generate an internal representation indicating a logical configuration including communication equipment nodes and communication path edges, and create configuration diagram data that visually represents the communication equipment and the communication paths based on the internal representation; and
output the configuration diagram data as image data or drawing description data and transmit the configuration diagram data and the explanation information to the terminal device via the communication interface as presentation information.

2. The system according to claim 1, wherein the circuitry is configured to extract, from the structured data, information corresponding to a scale of a usage site, a number of users, reliability requirements, and security requirements, and add the extracted information as consideration conditions to the prompt sentence.

3. The system according to claim 2, wherein the circuitry is configured to extract, from the explanation information, descriptions relating to types of communication devices, interconnection relationships, and logical segmentation, and generate the internal representation as a graph data structure comprising nodes corresponding to the communication devices and edges corresponding to communication links between the nodes, with attributes derived from the extracted descriptions.

4. The system according to claim 3, wherein the circuitry is configured to validate the internal representation against the structured data by applying predefined consistency rules that check connectivity between required endpoints, presence of security devices at a network boundary, existence of paths between access segments and service segments, and compliance with redundancy requirements.

5. The system according to claim 4, wherein the circuitry is configured to, when a configuration inconsistency is detected as a result of the validation, modify contents of the prompt sentence by inserting corrective clauses addressing the detected inconsistency, and perform re-input of the modified prompt sentence to the generative neural network model to acquire revised explanation information and regenerate the internal representation and the configuration diagram data.

6. The system according to claim 5, wherein the circuitry is configured to calculate positions for nodes and routes for edges of the internal representation using a hierarchical layout algorithm that orders the communication devices by logical layer, and transform the graph data structure into drawing description data by generating geometric coordinates, shapes, and labels corresponding to devices and links.

7. The system according to claim 6, wherein the circuitry is configured to convert the drawing description data into the image data using a rendering engine, the image data comprising a vector graphic or a raster graphic representing a network configuration diagram that includes routers, switches, firewalls, and connections among the routers, switches, and firewalls.

8. The system according to claim 1, wherein the circuitry is configured to store, in the storage device, deployment status information of the communication equipment and state information regarding connection target equipment, and generate the structured data to further include topology information, communication quality information indicating at least latency and bandwidth for each communication link, and connection requirement conditions.

9. The system according to claim 8, wherein the circuitry is configured to generate, based on the configuration diagram data and the communication quality information, graph data representing a plurality of candidate communication paths between pieces of equipment, and calculate an optimal communication path and an alternative communication path by applying a shortest-path algorithm with edge weights derived from a weighted combination of the latency, the bandwidth, and an error rate for each communication link.

10. The system according to claim 9, wherein the circuitry is configured to output the configuration diagram data and a calculation result regarding the communication paths as visualization data, the visualization data distinguishing the optimal communication path and the alternative communication path by different visual attributes, and transmit the visualization data to cause the terminal device to display a network configuration diagram including the pieces of equipment and the communication paths.

11. The system according to claim 10, wherein the circuitry is configured to acquire, via the terminal device, a natural language inquiry input by a user, generate a further prompt sentence including the inquiry and current network state data, and input the further prompt sentence to the generative neural network model to cause the generative neural network model to generate explanation information or modification proposals regarding the network configuration diagram and the communication paths.

12. The system according to claim 1, wherein the circuitry is configured to receive, from the terminal device, correction instructions for the configuration diagram data, reflect the correction instructions in the deployment information stored in the storage device, and update the prompt sentence for re-input to the generative neural network model to regenerate the configuration diagram data.

13. The system according to claim 12, wherein the circuitry is configured to record an update history including a timestamp and a description of each correction instruction, analyze the update history to detect recurring correction patterns, and dynamically adjust content of the prompt sentence based on the detected patterns to reduce a number of subsequent correction iterations.

14. The system according to claim 13, wherein the circuitry is configured to include, in the prompt sentence, conditions related to assignment of communication identifiers, route selection, and segmentation, and thereby acquire, from the generative neural network model, explanation information regarding a logical connection configuration and an address scheme corresponding to the configuration diagram data.

15. The system according to claim 1, wherein the circuitry is configured to acquire facial expression information from an imaging device and audio information from an audio acquisition device provided in the terminal device, and estimate an emotional state of a user by inputting the facial expression information and the audio information to an emotion estimation model.

16. The system according to claim 15, wherein the circuitry is configured to adjust, in accordance with the estimated emotional state of the user, at least one of the prompt sentence and an explanatory text obtained from the generative neural network model so as to simplify or detail the explanatory text, and generate explanatory information corresponding to an inferred comprehension level of the user.

17. The system according to claim 16, wherein the circuitry is configured to transmit the configuration diagram data and the explanatory information to the terminal device in a displayable format, wherein when the estimated emotional state indicates a stress level exceeding a predetermined threshold, the circuitry generates a simplified prompt sentence that instructs the generative neural network model to produce shorter sentences with reduced technical terminology in the explanatory text.

18. A system comprising:
circuitry configured to:
receive, via a communication interface coupled to a packet-switched network, deployment information relating to communication equipment from a terminal device, convert the deployment information into structured data according to a predetermined schema by mapping input fields into at least a site identifier, a device category, a device quantity, a required redundancy level, and a security classification, and store the structured data in an information management area of a storage device;
acquire the structured data stored in the information management area, extract information corresponding to a scale of a usage site, a number of users, reliability requirements, and security requirements, and generate, by using a template-based prompt generation module, a prompt sentence in a natural language that encodes the extracted information as constraint clauses for a transformer-based generative neural network model comprising a plurality of self-attention layers and feed-forward layers;
input the prompt sentence to the transformer-based generative neural network model and acquire explanation information regarding a network connection structure, the explanation information including descriptions of device roles, interconnection relationships, and segmentation structures;
parse the explanation information using extraction rules to identify device entities, link entities, and segmentation entities, and generate an internal representation as a graph data structure comprising nodes representing communication devices and edges representing communication paths, with attributes including device category, security zone, and link type;
validate the internal representation against the structured data by applying predefined consistency rules, and, when a configuration inconsistency is detected, modify contents of the prompt sentence by inserting corrective clauses and perform re-input of the modified prompt sentence to the transformer-based generative neural network model to acquire revised explanation information; and
create configuration diagram data based on the validated internal representation by calculating node positions using a layout algorithm and converting the graph data structure into drawing description data, and output the configuration diagram data as image data to the terminal device via the communication interface.

19. The system according to claim 18, wherein the transformer-based generative neural network model is trained using supervised learning on a dataset of network topologies and configuration diagrams by minimizing a cross-entropy loss between predicted tokens and reference tokens using a gradient-based optimization algorithm, and the circuitry is configured to constrain output of the transformer-based generative neural network model to a predefined schema of configuration operations and network element descriptors.

20. A method performed by circuitry of a system coupled to a packet-switched network via a communication interface, the method comprising:
receiving, via the communication interface, deployment information relating to communication equipment from a terminal device, and storing the deployment information as structured data in an information management area of a storage device;
acquiring the structured data stored in the information management area and generating, based on the structured data, a prompt sentence in a natural language to be used as an input instruction to a generative neural network model operating on a deep learning framework;
inputting the prompt sentence to the generative neural network model via an external interface and acquiring explanation information regarding a network connection structure output from the generative neural network model;
analyzing the explanation information to generate an internal representation indicating a logical configuration including communication equipment nodes and communication path edges, and creating configuration diagram data that visually represents the communication equipment and the communication paths based on the internal representation; and
outputting the configuration diagram data as image data or drawing description data and transmitting the configuration diagram data and the explanation information to the terminal device via the communication interface as presentation information.
